(19) United States
(12) Patent Application Publication
(10) Pub. No.: US 2018/0253797 A1
(43) Pub. Date: Sep. 6, 2018

(54) FAIR VALUE MODEL FOR FUTURES

(71) Applicant: ITG SOFTWARE SOLUTIONS, INC., Culver City, CA (US)

(72) Inventors: Nicholas Nowak, Salem, MA (US); Vitaly Serbin, Somerville, MA (US)

(73) Assignee: ITG SOFTWARE SOLUTIONS, INC., Culver City, CA (US)

(21) Appl. No.: 15/970,445

(22) Filed: May 3, 2018

Related U.S. Application Data
(63) Continuation of application No. 12/620,998, filed on Nov. 18, 2009.

(51) Int. Cl. G06Q 40/06

(52) U.S. Cl. CPC G06Q 40/06

(57) ABSTRACT

A computer implemented method and system for determining fair-value prices of a futures contract of index i having foreign constituent securities includes using a computer to receive electronic data for the index i. A computer can be used to calculate alpha (α) and beta (β) coefficients using a regression analysis. The alpha (α) coefficient represents a risk-adjusted measure of return on the index i, and the beta (β) coefficient represents a metric that is related to a correlation between an overnight return of the index i and a proxy market. A computer can receive a settlement price (SETTᵢ) for a futures contract for index i, and calculate a fair-value adjusted price for the futures contract of index i based at least in part on the alpha (α) and beta (β) coefficients, the futures contract settlement price (SETTᵢ) for index i, and at least one return of a predetermined factor (Zᵢ) during a stale period.

### CROSS-REFERENCE TO RELATED APPLICATION

This application claims the benefit of priority to U.S. Provisional Patent Application No. 61/115,660 filed Nov. 18, 2008, the entire contents of which is incorporated herein by reference.

### BACKGROUND OF THE INVENTION

### Field of the Invention

This invention relates generally to the field of electronic securities and futures contracts trading. More specifically, the present invention relates to a system, method, and computer program product for fairly and accurately valuing mutual funds having foreign-based or thinly traded assets. Additionally, the present invention relates to a system, method, and computer program product for fairly and accurately valuing futures contracts that are traded on foreign futures exchanges.

### Background of the Related Art

Open-end mutual funds provide retail investors access to a diversified portfolio of securities at low cost and offer investors liquidity on a daily basis, allowing them to trade fund shares to the mutual fund company. The price at which these transactions occur is typically the fund's Net Asset Value (NAV) computed on the basis of closing prices for the day of all securities in the fund. Thus, fund trade orders received during regular business hours are executed the next business day, at the NAV calculated at the close of business on the day the order was received. For mutual funds with foreign or thinly traded assets, however, this practice can create problems because of time differences between the foreign markets' business hours and the local (e.g. U.S.) business hours.

If NAV is based on stale prices for foreign securities, short-term traders can profit substantially by trading on news in the U.S. at the expense of the shareholders that remain in the fund. In particular, excess returns of 2.5, 9-12, 8 and 10-20 percent have been reported for various strategies suggesting, respectively, 4, 4, 6 and unlimited number of roundtrip trades of international funds per year; At least 16 hedge fund companies covering 30 specific funds exist whose stated strategy is “mutual fund timing.” Traditionally, funds have widely used short-term trading fees to limit trading timing profit opportunities, but the fees are neither large enough nor universal enough to protect long-term investors and profit opportunities remain even if such fees are used. Complete elimination of the trading profit opportunity through fees alone would require very high short-term trading fees, which may not be embraced by investors.

This problem has been known in the industry for some time, but in the past was of limited consequence because it was somewhat difficult to trade funds with international holdings. Funds' order submission policies required sometimes up to several days for processing, which did not allow short-term traders to take advantage of NAV timing situations. However, with the significant increase of Internet trading in recent years this barrier has been eliminated.

Short-term trading profit opportunities in international mutual funds are not as much of an informational efficiency problem as an institutional efficiency problem, which suggests that changes in mutual fund policies represent a solution to this problem. Further, the Investment Company Act of 1940 imposes a regulatory obligation on mutual funds and their directors to make a good faith determination of the fair value of the fund's portfolio securities when market quotations are not readily available. These concerns are relevant for stocks, bonds, and other financial instruments, especially those that are thinly traded.

It has been demonstrated that international equity returns are correlated at all times, even when one of the markets is closed, and the magnitude of the correlations may be very large. As a result, there are large correlations between observed security prices during the U.S. trading day and the next day's return on the international funds. However, according to a recent survey, only 13 percent of funds use some kind of adjustment. But even so, the adjustments adopted by some mutual funds are flawed, such that the arbitrage opportunities are not reduced at all.

The methods, systems, and computer products for determining fair-value prices of financial securities of international markets described above and claimed in co-owned U.S. Pat. No. 7,533,048 have been adopted by mutual fund families in an effort to minimize instances of market timing arbitrage. The repeal of 26 C.F.R. § 1.851(b)(3) in 1997 provided mutual fund managers with greater flexibility in the selection of hedging, trading, and investment strategies without the risk of violating the fund's status as a mutual fund. 26 C.F.R. § 1.851(b)(3) provided that a corporation could not be considered a mutual fund unless less than thirty percent of the corporation's gross income was derived from the sale or disposition of various financial instruments, including stocks and securities, futures and forward contracts, and foreign currencies, held for less than three months. The repeal of this section has led to the expansion of the strategic use of derivatives in mutual funds for various purposes. Specifically, index futures contracts have been used for at least the following reasons.

The managers of both active and passive mutual funds have a need to smooth out the portfolio transitions that are caused by cash inflows and outflows. That is, large purchases or sales of individual securities often result in sizable price impact costs. Therefore, in response to large cash inflows/outflows, mutual fund managers purchase/sell an appropriate amount of index futures contracts to maintain a desired market exposure or tracking error. The mutual fund managers then fine-tune the final mutual fund portfolio composition by trading individual securities.

Additionally, mutual fund managers use index futures contracts for hedging purposes. With many index futures contracts products in the market and more products constantly entering the market, it is possible for mutual fund managers to use index futures contracts not only to hedge out exposure to the market factor, but also the exposure to specific sectors and industries in the market.

Additionally, mutual fund managers can use index futures contracts to place non-covered bets on market/sector/industry direction. While it is possible to accomplish this through the use of the index constituents, using index futures contracts allows for more rapid adjustments due to at least the lower trading costs and higher liquidity in index futures contracts.

Consequently, there is a present need for fair value calculations that make adjustments to closing prices for liquidity, time zone, and other factors. Of these, time-zone adjustments have been noted as one of the most important challenges to mutual fund and custodians.

Additionally, because mutual fund managers are including index futures contracts in their investment strategies, there is a need to provide fair-value prices of index futures contracts. This stems, at least, from the need to provide consistent valuation of a mutual fund's portfolio when the portfolio's securities holdings are subjected to fair-value pricing. Moreover, the fair-valuing of index futures contracts addresses the concern many mutual fund managers have that future industry regulations/recommendations with require these adjustments.

### SUMMARY OF THE INVENTION

The present invention solves the existing need in the art by providing a system, method, and computer program product for computing the fair value of futures contracts, particularly index futures contracts, trading on international markets by making certain adjustments for time-zone differences between the time-zone of the futures contract, the time zone of U.S. exchanges, and in some cases the time-zone of the foreign exchange on which the constituents of the index are traded.

One embodiment of the present invention is a computer implemented method for determining fair-value prices of a futures contract of index i having foreign constituent securities. The method includes using a computer to receive electronic data for the index i. Once the data has been gathered, a computer is used to calculate alpha (α) and beta (β) coefficients using a regression analysis. The alpha (α) coefficient represents a risk-adjusted measure of return on the index i, and the beta (β) coefficient represents a metric that is related to a correlation between an overnight return of the index i and a proxy market. The method continues by receiving, by a computer, a settlement price (SETTᵢ) of the futures contract for index i. Then a computer is used to calculate a fair-value adjusted price for the futures contract of index i based at least in part on the alpha (α) and beta (β) coefficients, the settlement price of the futures contract (SETTᵢ) for index i, and at least one return of a predetermined factor (Zᵢ) during a stale period.

Another embodiment of the present invention is a system for determining fair-value prices of a futures contract of index i having foreign constituent securities. The system includes a fair-value computation server connected to an electronic data network (e.g., the Internet, LAN, etc.) and configured to receive electronic data for the index i from data sources via the electronic data network. The fair-value computation server is used to calculate alpha (α) and beta (β) coefficients using a regression analysis, receive a settlement price (SETTᵢ) of the futures contract for index i, and calculate a fair-value adjusted price for the futures contract of index i based at least in part on the alpha (α) and beta (β) coefficients, the futures contract settlement price (SETTᵢ) for index i, and at least one return of a predetermined factor (Zᵢ) during a stale period. The alpha (α) coefficient represents a risk-adjusted measure of return on the index i, and the beta (β) coefficient represents a metric that is related to a correlation between an overnight return of the index i and a proxy market.

Other objects and advantages of the present invention will be apparent to those skilled in the art upon review of the detailed description of the preferred embodiments below and the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 is a graph illustrating how an international security may be inaccurately priced by a domestic mutual fund in computing the fund's Net Asset Value;

FIG. 2 is a graph illustrating the use of a time-series regression to construct a fair value model of an international security's overnight returns when compared against a benchmark return factor, such as a snapshot U.S. market return;

FIG. 3 is a flow diagram illustrating a process for determining the fair value price of international securities according to a preferred embodiment of the invention;

FIG. 4 is a block diagram of a system (such as a data processing system) for implementing the process according to a preferred embodiment of the invention;

FIG. 5 is a flow diagram illustrating an exemplary process for determining the fair-value price of an index futures contract with foreign underlying constituent securities according to an embodiment of the present invention.

FIG. 6 is a timeline that illustrates a situation where index futures contracts trade after its index constituents, but stops trading before the U.S. markets close;

FIG. 7 is a timeline that illustrates a situation where index futures contracts stop trading near or after the U.S. markets close; and

FIG. 8 is a timeline that illustrates a situation where index futures contracts stop trading near its index constituents, but stops trading before the U.S. markets close.

### DETAILED DESCRIPTION OF THE PREFERRED EMBODIMENTS

This application relates to co-owned U.S. Pat. No. 7,533,048, entitled “Fair Value Model Based System, Method, and Computer Program Product for Valuing Foreign-Based Securities in a Mutual Fund,” the entire contents of which is incorporated herein by reference.

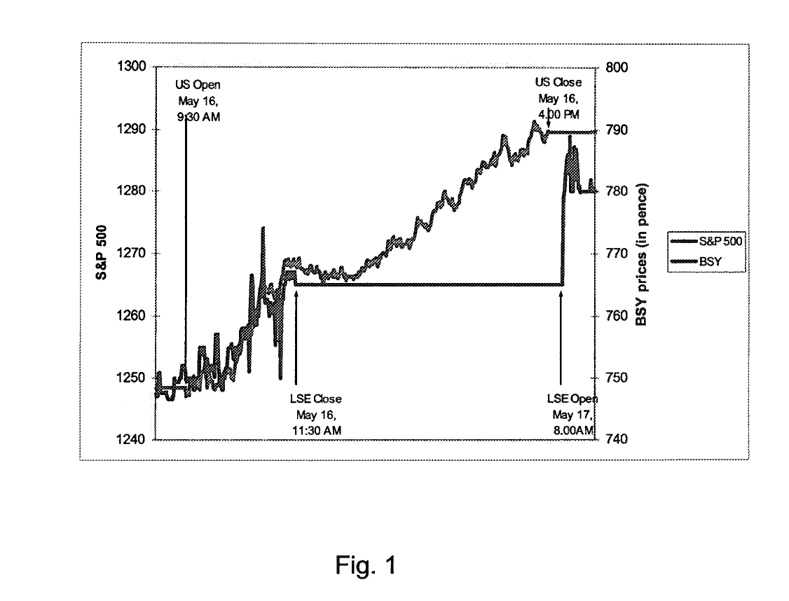

A general principle of the invention is illustrated by referring to FIG. 1. NAV of mutual fund shares is typically calculated at 4:00 p.m. Eastern Standard Time (EST), i.e., at the close of the U.S. financial markets (including the NYSE, ASE, and NASDAQ markets). This is well after many, if not most, foreign markets already have closed. Thus, events, news and other information observed between the close of the foreign market and 4:00 p.m. EST may have an effect on the opening price of foreign securities on the next business day (and thus is likely also to have an effect on the next day's closing price), that is not reflected in the calculated NAV based on the current day's closing price.

FIG. 1 illustrates an example of the opportunity for trading profit. Stock BSY (British Sky Broadcasting PLC) is traded on the London Stock Exchange (LSE). On May 16, 2001, the stock closed at 767 pence at 11:30 a.m. EST. After the LSE's close, the US stock market had a significant increase—between 11:30 a.m. and 4 p.m. EST, the S&P 500 Index had risen by 1.6%. As seen from the chart, during the time that both the LSE and the U.S. stock exchanges were open, the price of BSY had a high correlation with the S&P 500 Index. The closing price of BSY obviously did not reflect the increase of the U.S. market between 11:30 a.m. and 4:00 p.m. EST. But BSY's next day opening price increased by 1.56% (to 779 pence) due mostly to the U.S. market rise the previous day. An obvious arbitrage strategy would have suggested buying a mutual fund that included stock BSY on May 16, with the fund's NAV based on BSY's closing price of 767 pence, and then selling it on the next day. This is a very efficient and low-risk strategy, since most likely BSY's closing price for May 17 would have been higher as a result of the higher opening price. To exclude the possibility of such an arbitrage, BSY's closing price for May 16 could be adjusted to a “fair” price based on a Fair Value Model (FVM).

Because there is no direct observation of the fair value price of a foreign stock at 4 p.m. EST, the next day opening price is commonly used as a proxy for a “fair value” price. Such a proxy is not a perfect one, however, since there is a possibility of events occurring between 4 p.m. EST and the opening of a foreign market, which may change stock valuations. However, there is no reason to believe that the next day opening price proxy introduces any systematic positive or negative bias.

The goal of FVM research is to identify the most informative factors and the most efficient framework to estimate fair prices. The goal assumes also a selection of criteria to facilitate the factor selection process. In other words, it needs to be determined whether factor X needs to be included in the model while factor Y doesn't add any useful information, or why framework A is more efficient than framework B. Unlike a typical optimization problem, there is no single criterion for the fair value pricing problem. Several different statistics reflect different requirements for FVM performance and none of them can be seen as the most important one. Therefore a decision on selection of a set of factors and a framework should be made when all or most of the statistics clearly suggest changes in the model when compared with historical data. All the criteria or statistics are considered below.

There are many factors which can be used in FVM: the U.S. intra-day market and sector returns, currency valuations, various types of derivatives—ADRs (American Depository Receipts), ETFs (Exchange Traded Funds), futures, etc. The following general principles are used to select factors for the FVM:
economic logic—factors must be intuitive and interpretable;
the factors must make a significant contribution to the model's in-sample (i.e., historical) performance;
the factors must provide good out-of-sample or back-testing performance.

It must be understood that good in-sample performance of factors does not guarantee a good model performance in actual applications. The main purpose of the model is to provide accurate forecasts of fair value prices or their proxies—next day opening prices. Therefore, only factors that have a persistent effect on the overnight return can be useful. One school of thought holds that the more factors that are included in the model, the more powerful the model will be. This is only partly true. The model's in-sample fit may be better by including more parameters in the model, but this does not guarantee a stable out-of-sample performance, which should be the most important criterion in developing the model. Throwing too many factors into the model (the so-called “kitchen sink” approach) often just introduces more noise, rather than useful information.

In the equations that follow, the following notations are used:

rᵢ is the overnight return for stock i in a foreign market, which is defined as the percentage change between the price at the foreign market close and that market's price at the open on the next day;
m is the snapshot U.S. market return between the closing of a foreign market and the U.S. closing using the market capitalization-weighted return based on Russell 1000 stocks as a proxy;
sⱼ is the snapshot excess return of the j-th U.S. sector over the market return, where the return is measured between the closing of a foreign market and the U.S. closing, again using the Russell 1000 sector membership as a proxy, where sector is selected appropriately;
ε represents price fluctuations.

In developing an optimized fair value model, the following statistics should be considered. These statistics measure the accuracy of a fair value model in forecasting overnight returns of foreign stocks by measuring the results obtained by the fair value model using historical data with a benchmark.

Average Arbitrage Profit (ARB) measures the profit that a short-term trader would realize by buying and selling a fund with international holdings based on positive information observed after the foreign market close. Thus, when a fund with international holdings computes its net asset value (NAV) using stale prices, short-term traders have an arbitrage opportunity. To take advantage of information flow after the foreign market close, such as a large positive U.S. market move, the arbitrage trader would take a long overnight position in the fund so that on the next day, when the foreign market moves upwards, the trader would sell his position to realize the overnight gain. However, once a fair value model is utilized to calculate NAV, any profit realized by taking an overnight long position represents a discrepancy between the actual overnight gain and the calculated fair value gain. A correctly constructed Fair Value Model should significantly minimize such arbitrage opportunities as measured by the out-of-sample performance measure as

$$\begin{matrix}Arbitrage Profit with FVM ( ARB ) = \frac{1}{T} {\sum }_{m \geq 0} ( {q}_{t} - {\hat{q}}_{t} ) + \frac{1}{T} {\sum }_{m < 0} ( {\hat{q}}_{t} - {q}_{t} ) , & ( 1 ) \\ Arbitrage Profit without FVM = \frac{1}{T} {\sum }_{m \geq 0} {q}_{t} - \frac{1}{T} {\sum }_{m < 0} {q}_{t} , & ( 2 )\end{matrix}$$

where T is the number of out-of-sample periods, qₜ is the overnight return of an international fund at time t, and \hat{q}ₜ, is the forecasted return by the fair value model.

The above statistics provide average arbitrage profits over all the out-of-sample periods regardless of whether there has been a significant market move. A more informative approach is to examine the average arbitrage profits when the U.S. market moves significantly. Without loss of generality, we define a market move as significant if it is greater in magnitude than half of the standard deviation of daily market return.

Arbitrage Profit with FVM for Large Moves

$$\begin{matrix} ( ARBBIG ) = \frac{1}{{T}_{lp}} {\sum }_{m \geq σ / 2} ( {q}_{t} - {\hat{q}}_{t} ) + \frac{1}{{T}_{lp}} {\sum }_{m \leq - σ / 2} ( {\hat{q}}_{t} - {q}_{t} ) , & ( 3 ) \\ Arbitrage Profit without FVM for Large Moves = \frac{1}{{T}_{lp}} {\sum }_{m \geq σ / 2} {q}_{t} - \frac{1}{{T}_{lp}} {\sum }_{m \leq σ / 2} {q}_{t} , & ( 4 )\end{matrix}$$

where σ is the standard deviation of the snapshot U.S. market return and Tₗₚ is the number of large positive moves (i.e. the number of times m≥σ/2). The surviving observations cover approximately 60% of the total number of trading days. The arbitrage profit statistics are calculated as follows:
for any given stock and any given estimation window, run the regression and compute the forecasted overnight return;
compute the deviation of the realized overnight returns from the forecasted returns;
depending on the size of U.S. market moves, take the appropriate average of the deviation over a selected stock universe and over all estimation windows.

It is to be noted that the arbitrage profit statistic is potentially misleading. This happens when the fair value model over-predicts the magnitude of the overnight return, and thus reduces the arbitrage profit because such over-prediction would result in a negative return on an arbitrage trade. For this reason, use of arbitrage profit does not lead to a good fair value model because the fair value model should be constructed to reflect as accurately as possible the effect of observe information on asset value rather than to reduce arbitrage profit.

Mean Absolute Error (MAE). While mutual funds are very concerned with reducing arbitrage opportunities, the SEC is just as concerned with fair value issues that have a negative impact on the overnight return of a fund with foreign equities. This information is useless to the arbitrageur because one cannot sell short a mutual fund. Nonetheless, evaluation of a fair value model must consider all circumstances in which the last available market price does not represent a fair price in light of currently available information. MAE measures the average absolute discrepancy between forecasted and realized overnight returns:

$$\begin{matrix}Mean Absolute Error with FVM ( MAE ) = \frac{1}{T} \sum \vert {r}_{t} - {\hat{r}}_{t} \vert , & ( 5 ) \\ Mean Absolute Error without FVM = \frac{1}{T} \sum \vert {r}_{t} \vert . & ( 6 )\end{matrix}$$

The MAE calculation involves the following steps:
for any given stock and any given estimation window, run the regression and compute the forecasted overnight return;
compute the absolute deviation between the realized and the forecasted overnight returns;
take an average of the absolute deviation over a selected universe and over all estimation windows.

Time-series out-of-sample correlation between forecasted and realized returns (COR) measures whether the forecasted return of a given stock varies closely related to the variation of the realized return. It can be computed as follows:
for any given stock and any given estimation window, run the regression and compute the forecasted overnight return and obtain the actual realized return;
keep the estimation window rolling to obtain a series of forecasted returns and a series of realized returns for this stock and compute the correlation between the two series;
take an average over a selected stock universe.

Hit ratio (HIT) measures the percentage of instances that the forecasted return is correct in terms of price change direction:
for any given stock and any given estimation window, run the regression and compute the forecasted overnight return;
define a dummy variable, which is equal to one if the realized and the forecasted overnight returns have the same sign (i.e., either positive or negative) and equal to zero otherwise;
take an average of the defined dummy variable over a selected stock universe and over all estimation windows.

Similar to how ARBBIG is defined above, it is more useful to calculate the statistics only for large moves. Values of HIT in the tables in the Appendix below are calculated for all observations. The methodology for obtaining an optimized Fair Value Model are now described.

The overnight returns of foreign stocks are computed using Bloomberg pricing data. The returns are adjusted if necessary for any post-pricing corporate actions taken. The FVM universe covers 41 countries with the most liquid markets (see all the coverage details in Appendix 1), and assumes Bloomberg sector classification including the following 10 economic sectors: Basic Materials, Communications, Consumer Cyclical, Consumer Non-cyclical, Diversified, Energy, Financial, Industrial, Technology and Utilities.

Since all considered frameworks are based on overnight returns, it is important to determine if overnight returns behave differently for consecutive trading days versus non-consecutive days. Such different behavior may reflect a correlation between length of time period from previous trading day closing and next trading day opening and corresponding volatility. If such difference can been established, a fair value model would have to model these two cases differently. To address this issue, the average absolute value of the overnight returns for any given day was used as the measure of overnight volatility and information content. The analysis, however, demonstrated that there is no significant difference between the overnight volatility of consecutive trading days and non-consecutive trading days for all countries (see results of the study in Appendix 2).

These results are consistent with several studies, which demonstrate that volatility of stock returns is much lower during non-trading hours.

The following regression models are examples of possible constructions of a fair value model according to the invention. In the following equations, the return of a particular stock is fitted to historical data over a selected time period by calculating coefficients β, which represent the influence of U.S. market return or U.S. sector return on the overnight return of the particular foreign stock. The factor ε is included to compensate for price fluctuations.

### Model 1 (Market and Sector Model):

rᵢ=β^{m}m+β^{s}sⱼ+ε

Model 1 assumes that the overnight return is determined by the U.S. snapshot market return m and the respective snapshot sector return sⱼ.

### Model 2 (Market Model):

rᵢ=β^{m}m+ε

Model 2 is similar to Capital Asset Pricing Model (CAPM) and is a restricted version of Model 1.

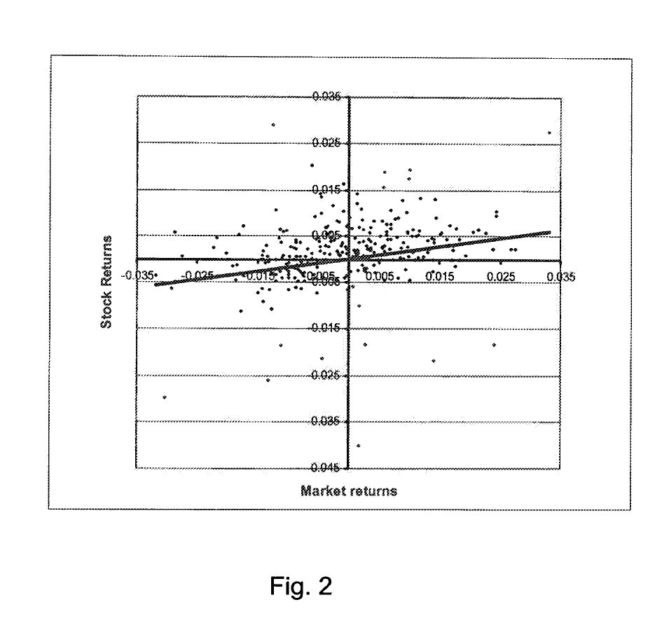

FIG. 2 illustrates how regression of a stock's overnight return on the U.S. snapshot return can be built. The observations were taken for Australian stock WPL (Woodside Petroleum Ltd.) for the period between Jan. 18, 2001 and Mar. 21, 2002.

### Model 3 (Sector Model):

rᵢ=β^{s}(sⱼ+m)+ε

Model 3 is based on the theory that the stock return is only affected by sector return. The term sⱼ+m represents the sector return rather than the sector excess return. The sector can be selected based on various rules, as described below.

### Model 4 (Switching Regression Model)

It may be possible that a stock's price reacts to market and sector changes as a function of the magnitude of the market return. Intuitively, asset returns might exhibit higher correlation during extreme market turmoil (so-called systemic risk). Such behavior can be modeled by the so-called switching regression model, which is a piece-wise linear model as a generalization of a benchmark linear model. Taking Model 1 as the benchmark model, a simple switching model is described as follows

$${r}_{i} = \{ \begin{matrix}{β}_{i}^{m} m + {β}_{i}^{s} {s}_{j} + ɛ , & if \vert m \vert \leq c ; \\ ( {β}_{i}^{m} + {δ}_{i}^{m} ) m + ( {β}_{i}^{s} + {δ}_{i}^{s} ) {s}_{j} + ɛ , & if \vert m \vert > c .\end{matrix}$$

This model assumes the sensitivities of stock return rᵢ to the market and the sector are βᵢ^{m} and βᵢ^{s} if the market change is less than the threshold c in magnitude. However, when the market fluctuates significantly, the sensitivities become βᵢ^{m}+δᵢ^{m} and βᵢ^{s}+δᵢ^{s} respectively. Alternately, multiple thresholds can be specified, which would lead to more complicated model structures but not necessarily better out-of-sample performances.

Although this model specifies the stock return as a non-linear function of market and sector returns, if we define a “dummy” variable

$$d = \{ \begin{matrix}0 , & if \vert m \vert \leq c ; \\ 1 , & if \vert m \vert > c ;\end{matrix}$$

the switching regression model becomes a linear regression

rᵢβᵢₘm+δᵢₘ(m*d)+βᵢₛsᵢ+δᵢₛ(sᵢ*d)+εᵢ.

Standard tests to determine whether the sensitivities are different as a function of different magnitudes of market changes are t-statistics on the null hypotheses δᵢ^{m}0 and δᵢ^{s}=0.

According to the invention, once a fair value regression model is constructed using one or more selected factors as described above, an estimation time window or period is selected over which the regression is to be run. Historical overnight return data for each stock in the selected universe and corresponding U.S. market and sector snapshot return data are obtained from an available source, as is price fluctuation data for each stock in the selected universe. The corresponding 13 coefficients are then computed for each stock, and are stored in a data file. The stored coefficients are then used by fund managers in conjunction with the current day's market and/or sector returns and price fluctuation factors to determine an overnight return for each foreign stock in the fund's portfolio of assets, using the same FVM used to compute the coefficients. The calculated overnight returns are then used to adjust each stock's closing price accordingly, in calculating the fund's NAV.

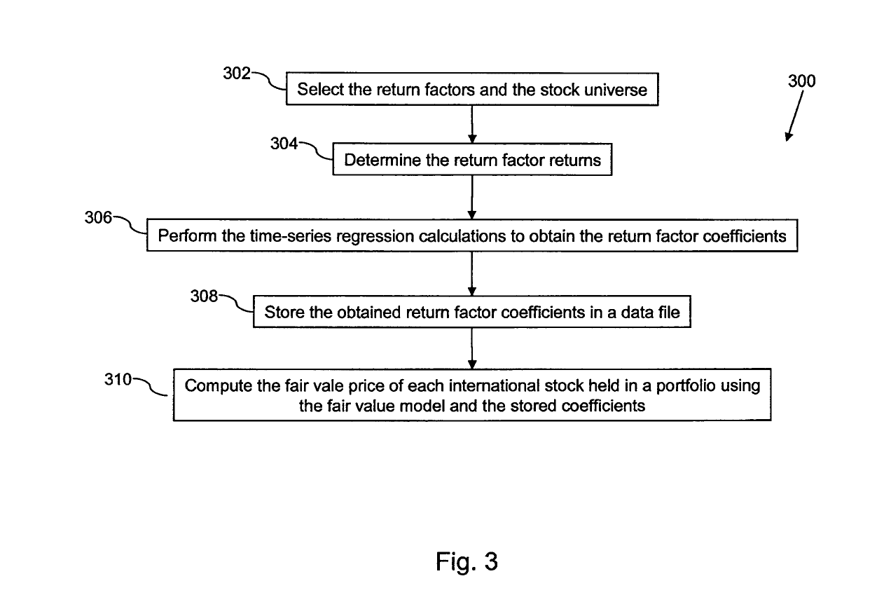

FIG. 3 is a flow diagram of a general process 300 for determining a fair value price of an international security according to one preferred embodiment of the invention. At step 302, the stock universe (such as the Japanese stock market) and the return factors as discussed above are selected. At step 304, the overnight returns of the selected return factors are determined using historical data. At step 306, the β coefficients are determined using time-series regression. At step 308, the obtained β coefficients are stored in a data file. At step 310, fair value pricing of each security in a particular mutual fund's portfolio is calculated using the fair model constructed of the selected return factors, the stored coefficients, and the actual current values of the selected return factors, in order to obtain the projected overnight return of each security. The projected overnight return thus obtained is used to adjust the last closing price of each corresponding international security accordingly, so as to obtain the fair value price to be used in calculating the fund's NAV.

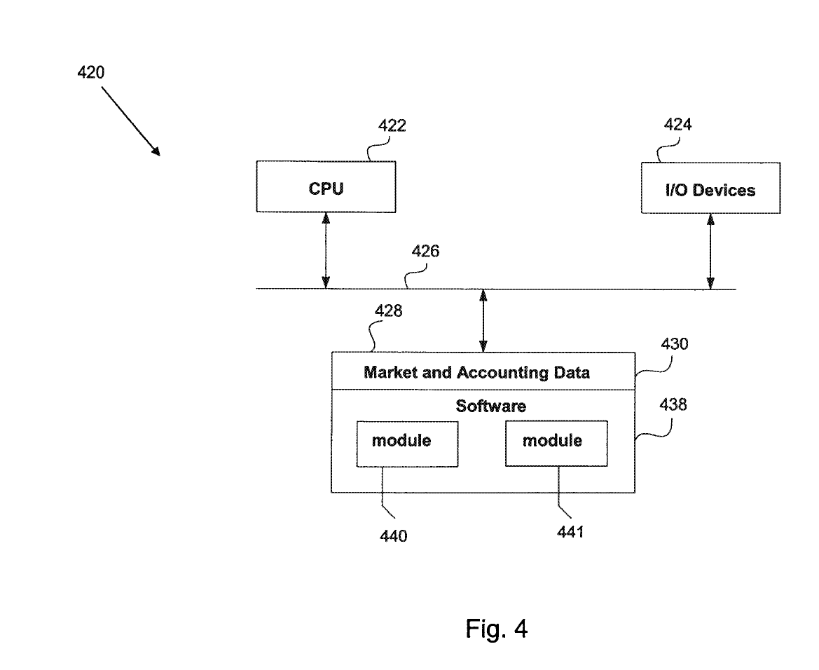

FIG. 4 shows a particular device, such as a computer system, 420, that can be used to implement methods, described herein, according to a preferred embodiment of the invention. The computer system 420 includes a central processing unit (CPU) 422, which communicates with a set of input/output (I/O) devices 424 over a bus 426. The I/O devices 424 may include a keyboard, mouse, video monitor, printer, etc. The computer system 420 may be in electronic communication with an electronic data network. The computer system, via an electronic data network, may access data storage devices, data feeds, additional processing, and other sources/repositories of computer readable data.

The CPU 422 also communicates with a computer-readable storage medium (e.g., conventional volatile or non-volatile data storage devices) 428 (hereafter “memory 428”) over the bus 426. The interaction between a CPU 422, I/O devices 424, a bus 426, and a memory 428 are well known in the art.

Memory 428 can include market and accounting data 430, which includes data on stocks, such as stock prices, and data on corporations, such as book value.

The memory 428 also stores software 438. The software 438 may include a number of modules 440 for implementing the steps of the processes described herein. Conventional programming techniques may be used to implement these modules. Memory 428 can also store the data file(s) discussed above.

The sector for Models 1, 2, 4 can be selected by different rules described as follows.
a) Sector determined by membership: The sector by membership usually does not change over time if there is no significant switch of business focus.
b) Sector associated with largest R²: This best-fitting sector by R² changes over different estimation windows and depends on the specific sample. It usually provides higher in-sample fitting results by construction but not necessarily better out-of-sample performance. This approach is motivated by observing that the sector classification might not be adaptive to fully reflect the dynamics of a company's changing business focus.
c) Sector associated with the highest positive t-statistic: Once again, this best-fitting sector changes over different estimation windows and depends on the specific sample. It has the same motivation as the prior sector selection approach. In addition, it is based on the prior belief that sector return usually has positive impact on the stock return.

Models 1, 2, 4 may use one of these types of selection rules; in exhibits of Appendix 3 they are referenced as 1b or 2c, indicating the sector selection method.

To evaluate fair value model performance for different groups of stocks, all models defined above have been run, the market cap-weighted R² values were computed for different universes, and an average was taken over all estimation windows. Each estimation window for each stock includes the most recent 80 trading days. The parameter selected after several statistical tests was chosen as the best value, representing a trade-off between having stable estimates and having estimates sensitive enough for the latest market trends. Tables 3.1, 3.2, and 3.3 present the results using Model 1a, Model 1b, and Model 1c. Results on the other models suggest similar pattern and are not presented here.

The results clearly suggest that all the models work better for large cap stocks than for small cap stocks. In addition, it can be observed that the R² values of Model 1b are the highest by construction and the R² values of Model 1a are the lowest.

Standard statistical testing has been implemented to examine whether switching regression provides a more accurate framework to model fair value price. One issue arising with the switching regression model is how to choose the threshold parameter. Since it is known that the selection of the threshold does not change the testing results dramatically as long as there are enough observations on each side of the threshold, we chose the sample standard deviation as the threshold. Therefore, approximately one-third of the observations are larger than the threshold in magnitude. Appendix 4 presents the percentages of significant positive δ using Model 2 as the benchmark. It shows that only a small percentage of stocks support a switching regression model.

As mentioned above, back-testing performance is an important part of the model performance evaluation. All back-testing statistics presented below are computed across all the estimation windows and all stocks in a selected universe. The average across all stocks in a selected universe can be interpreted as the statistics of a market cap-weighted portfolio across the respective universe. Appendix 7 contains all the results for selected countries representing different time zones with the most liquid markets, while Appendices 5 and 6 contain selected statistics for comparison purposes.

The out-of-sample performance was evaluated for all models containing a sector component and the pre-specified economic sector model performed the best. It is generally associated with the smallest MAE, the highest HIT ratio, and the largest correlation (COR).

Table 6.1 of Appendix 6 presents the MAE, HIT, and COR statistics of models with pre-specified sectors for top 10% stocks. It shows that model 2 performs the best. Table 6.2 summarizes the arbitrage profit statistics of model 2 for top 10% stocks in each of the countries. However, it is noted that all the models perform very well in terms of reducing arbitrage profit.

Table 6.2 of Appendix 6 also shows that less arbitrage profit can be made by short-term traders for days with small market moves. Consequently, fund managers may wish to use a fair value model only when the U.S. market moves dramatically.

Appendix 8 is included to demonstrate that the naïve model of simply applying the U.S. intra-day market returns to all foreign stocks closing prices does not reflect fair value prices as accurately as using regression-based models.

The US Exchange Traded Funds (ETF) recently have played an increasingly important role on global stock markets. Some ETFs represent international markets, and since they may reflect a correlation between the US and international markets, it might expected that they may be efficiently used for fair value price calculations instead of (or even in addition) to the U.S. market return. In other words, one may consider

### Model 2″ (ETF Model):

rᵢ=β^{e}e+ε

where e is a country-specific ETF's return, or

### Model 2′″(Market and ETF Model):

rᵢ=β^{m}m+β^{e}e+ε

The back-testing results, however, don't indicate that model 2″ performs visibly better than Model 2. Addition of ETF return to Model 2 in Model 2′″ does not make a significant incremental improvement either. Poor performance of ETF-based factors can be explained by the fact that country-specific ETFs are not sufficiently liquid. Some ETFs became very efficient and actively used investment instruments, but country-specific ETFs are not that popular yet. For example, EWU (ETF for the United Kingdom) is traded about 50 times a day, EWQ (ETF for France)—about 100 times a day, etc. The results of the tests for ETFs are included in the Appendix 9.

Some very liquid international securities are represented by an ADR in the U.S. market. Accordingly, it may be expected that the U.S. ADR market efficiently reflects the latest market changes in the international security valuations. Therefore, for liquid ADRs, the ADR intra-day return may be a more efficient factor than the U.S. market intra-day return. This hypothesis was tested and some results on the most liquid ADRs for the UK are included in Appendix 10. They suggest that for liquid securities ADR return may be used instead of the U.S. market return in Model 2.

As demonstrated above, it is reasonable to expect that different frameworks work differently for different securities. For example, as described above, for international securities represented in the U.S. market by ADRs it is more efficient to use the ADR's return than the U.S. market return, since theoretically the ADR market efficiently accounts for all specifics of the corresponding stock and its correlation to the U.S. market. Some international securities such as foreign oil companies, for example, are expected to be very closely correlated with certain U.S. sector returns, while other international securities may represent businesses that are much less dependent on the U.S. economy. Also, for markets which close long before the U.S. market opening, such as the Japanese market, the fair value model may need to implement indices other than the U.S. market return in order to reflect information generated during the time between the close of the foreign market and the close of the U.S. market.

Such considerations suggest that the framework of the fair value model should be both stock-specific and market-specific. All appropriate models described above should be applied for each security and the selection should be based on statistical procedures.

The fair value model according to the invention provides estimates on a daily basis, but discretion should be used by fund managers. For instance, if the FVM is used when U.S. intra-day market return is close to zero, adjustment factors are very small and overnight return of international securities reflect mostly stock-specific information. Contrarily, high intra-day U.S. market returns establish an overriding direction for international stocks, such that stock-specific information under such circumstances is practically negligible, and the FVM's performance is expected to be better. Another approach is to focus on adjustment factors rather than the US market intra-day return and make decisions based on their absolute values. Table 11.1 and 11.2 from Appendix 11 provide results of such test for both approaches. The test was applied to the FTSE 100 stock universe for the time period between April 15 and Aug. 23, 2002. The results demonstrate that FVM is efficient if it is used for all values of returns or adjustment factors.

### Fair-Value Pricing of Futures:

As described in detail above with regard to securities held in a mutual fund portfolio, the two pieces of information that are used in fair-value pricing are the stale price of a constituent security for which the fair-value adjustment is applied and the factor(s) which have to be actively traded during the period in which the price of the constituent security is stale (i.e., the stale period of the constituent security). This approach can be used, according to one embodiment of the invention, to provide fair-value adjustments for the price of index futures contracts.

An index measures the change in price in a group of underlying security constituents. For example, the S&P 500 is an index that measures the change in price of 500 large-cap common stocks that are actively traded in the U.S. There are indexes that are composed of foreign constituent securities. For example, the Hang Seng (HIA) is a Chinese index that measures the change in price of the 45 largest companies on the Hong Kong stock market. The constituent securities of the HIA index are foreign to the U.S, and thus are traded during hours that differ from the hours that U.S. markets are operated. The HIA index constituents are traded between the hours of 9:50 p.m. and 4:00 a.m. EST. Thus, the individual constituent securities of the HIA index have a 12 hour stale period of between the hours of 4:00 a.m. and 4:00 p.m. As described above, these constituent securities can have fair-value adjustments applied to them. Additionally, a fair-value adjustment may be applied to the index as a whole.

According to an embodiment of the present invention, a threshold step for determining the fair-value adjustment for index futures contracts is to first determine if the index futures contracts need adjusting.

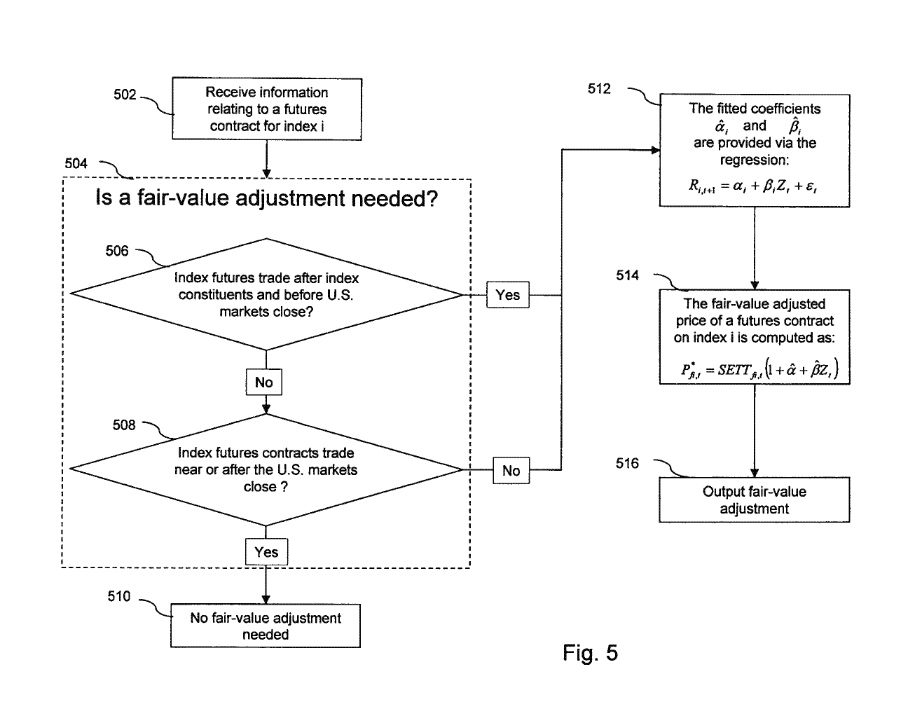

FIG. 5 is a flow diagram illustrating an exemplary process for determining the fair-value price of an index futures contract with foreign underlying constituent securities according to an embodiment of the present invention. At step 502, data relating to the index and the index futures contract is gathered for further analysis. This step, according to an embodiment of the present invention, can be accomplished using the computer system 420, which is in electronic communication with sources of electronic trading data. The data needed for analysis is described in further detail below.

At step 504, it is determined if an adjustment for index futures contracts is necessary. The trading times of the index futures contract, the local underlying exchange, and the influencing market should be considered. Unless expressly noted, the influencing market is the U.S. market, which currently opens at 9:30 a.m. EST and closes at 4:00 p.m. EST.

When considering the relationship of the trading times, at least three general patterns emerge: index futures contracts that trade after the market on which its index constituents close and before U.S. markets close, index futures contracts that trade near or after U.S. markets close, and index futures contracts that close near the markets on which its index constituents trade and before U.S. markets close. It is contemplated that more specific and complex patterns could likewise be observed and utilized in the practice of the current invention.

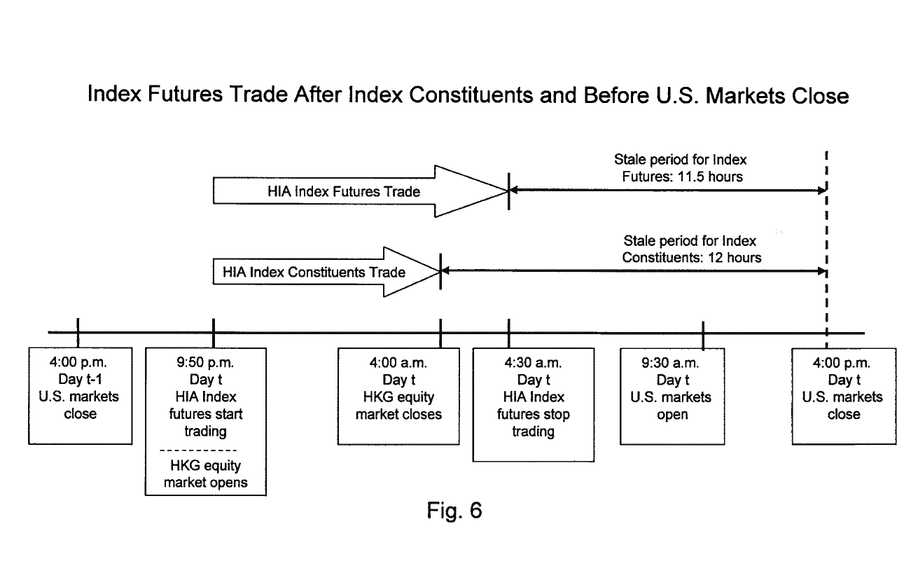

At step 506, it is determined if the index futures contract trades after the index constituents and before the U.S. markets close. FIG. 6 is a timeline that illustrates exemplary index futures contracts that trade after the market on which the index constituents close and before U.S. markets close. The timeline shows the relationship between the trading times of HIA index futures contracts, the underlying HIA index constituents on HKG equity market, and the U.S. markets. As shown, there can be two different stale periods: the stale period for the index futures contract and the stale period for the index constituents. The fair-value adjustment of an index futures contract can be keyed off of either of the stale periods. Additionally, it is contemplated that both stale periods could be used to provide fair-value adjustments for index futures contracts.

If at step 506 it is determined that the index futures trade after the index constituents and before the U.S. markets close, then the index futures contract needs a fair-value adjustment and the method continues at step 512. Otherwise the method continues at step 508.

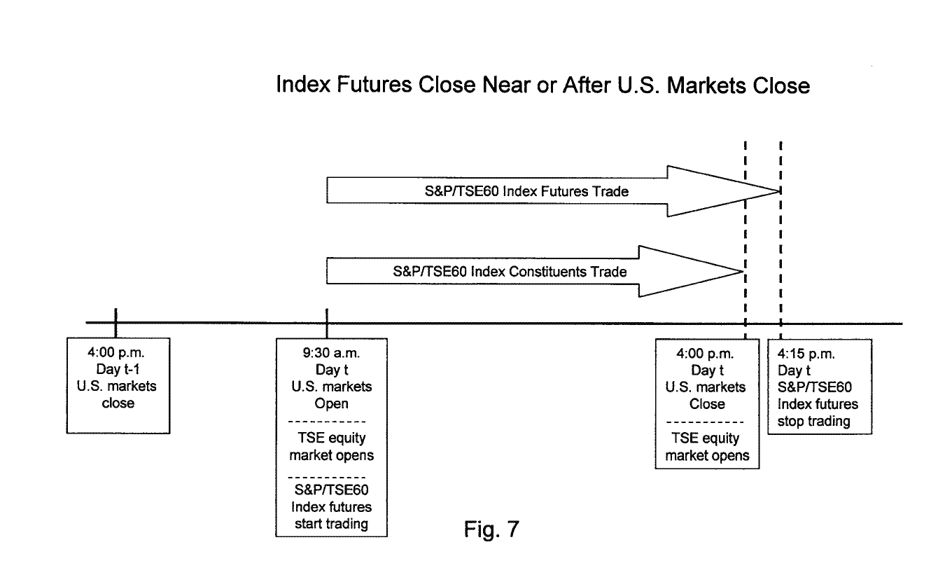

At step 508, it is determined if the index futures contract trades near or after the U.S. markets close. FIG. 7 is a timeline that illustrates exemplary index futures contracts that trade near or after the U.S. markets close. The timeline shows the relationship between the trading times of S&P/TSE 60 index futures contracts, the underlying S&P/TSE 60 index constituents on the TSE equity market, and the U.S. markets. As shown here, there is no stale period. If at step 508, it is determined that the index futures contract trades near or after the U.S. markets close then, generally, no fair-value adjustment is needed and the method terminates at step 510. Otherwise the method continues at step 512.

The preceding paragraphs assume that the index futures contract is liquid and is being traded on a particular day. However, there may remain the need to provide fair-value adjustments to illiquid index futures contracts and/or index futures contracts that have constituents that are traded on a market that did not trade on a particular day. This may occur for example on holidays that are observed by local foreign exchanges.

According to an embodiment of the present invention, some fund managers prefer to use a fair-value model in valuing index futures contracts even when there is no true stale period, as shown in FIG. 7 and described above. In this case, a fair-value adjustment can be applied to a settlement price generated by the exchange prior to close and before the close of the U.S. market. Thus, an artificial stale period can be created, beginning at the time the settlement price is generated by the exchange and ending at the close of the U.S. market. A fair-value adjustment can then be applied to this artificial stale period.

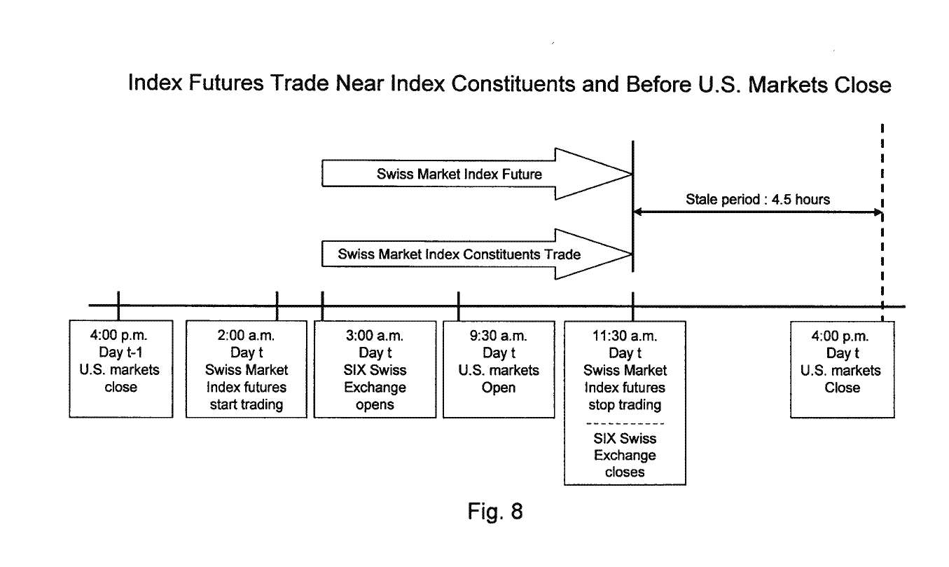

FIG. 8 is a timeline that illustrates examples of index futures contracts that close near the time the markets on which the index constituents trade and before U.S. markets close. The trading timeline illustrated in FIG. 8 would not be checked in step 504 of FIG. 5 because once the determinations of steps 506 and 508 have been made, the only remaining trading timeline is that which is illustrated in FIG. 8. Thus, the “No” branch of step 508 is also a determination that the trading timeline being analyzed is that which is shown in FIG. 8.

FIG. 8 shows the relationship between the trading times of Swiss Market index futures contracts, the underlying Swiss Market index constituents on the SIX Swill Exchange, and the U.S. Markets. As is illustrated, there is effectively one stale period when the index futures contracts trading closes around the same time as the market that the index constituents are traded on. If at step 508 it is determined that the index futures contract closes near the markets on which the index constituents and before U.S. markets close, then the index futures contract needs a fair-value adjustment and the method continues at step 512. Otherwise, the method terminates at step 510, and no fair-value adjustment is needed.

Generally, the index will have a more recent price than illiquid index futures contracts. An exception being when index futures contracts are traded on a day when the underlying index constituents are not traded, the index futures contracts will have a more recent price.

Fair-value adjustments for an index can be determined using a top-down approach. In the top-down approach, the fair-value adjustment for an index can be determined by treating the index like a single composite security. In discussing this method the following notations will be used:
\hat{α}ᵢ: Fitted coefficient. a is a risk-adjusted measure of return on the index i. According to an embodiment of the present invention \hat{α}ᵢ is set to zero to exclude possible error due to noisy data. In another embodiment of the present invention \hat{α}ᵢ is not set to zero, and thus the use of a non-zero \hat{α}ᵢ allows the fair-value model that is described below, to adjust for hidden or omitted considerations that may influence the fair-value price of the index i;
\hat{β}ᵢ: Fitted coefficient. β is a metric that is related to the correlation between the overnight return of the index i and the proxy market;
R_{i, t+1}: The next day return of index i;
Zₜ: The return of a predetermined factor during a stale period may affect the fair-value price of the futures contract for index i. According to one embodiment of the present invention, predetermined factor Z is one of a choice of index futures contracts which trade 24 hours/day and/or country level exchange-traded funds (ETFs). Examples of index futures contracts that can be used as factor Z are futures contracts that are based on the Nikkei 225 and S&P 500 indexes;
S_{i,t}: Today's closing price for index i;
i: Index of securities;
r: The prevailing risk-free rate (usually a rate on 3-month T-bill);
d: The expected dividend yield over the life of the futures contract for index i;
T: The expiration date of the futures contract for index i;
P*_{fi,t}: The predicted fair-value adjusted price for the futures contract on index i;
SETT_{fi}: The settlement price of a futures contract on index i;
\tilde{S}_{i,t}: The exchange computed value of the index i that can be used to compute SETTᵢ. The methodology of computing \tilde{S}_{i,t} varies from one exchange to another, but typically it is computed as the average price of the underlying index during a narrow (˜5 minute) interval immediately prior to the close of trading; and
e^{(r-d)(T-t)}: The cost of carry component. The cost of carry is estimated from the “tick” data (intraday quotes) for the index futures contracts and the corresponding index data during common trading hours of the most recent trading day. Using the intraday data allows the cost of carry to be computed without knowing the appropriate dividend yield and interest rate information. According to an embodiment of the present invention the cost of carry may be included in the settlement price (SETTᵢ), e.g., when provided by an exchange.

According to one embodiment of the present invention, on the latest trading day for which intraday data is available for both the underlying index and the future, the intersection of trading periods are found and analyzed. For each tick value in the future stream, the price data is interpolated between the two nearest time stamps of the index data and the estimate is averaged over the values of this single day. This method of backing out the cost of carry is advantageous because dividend information and interest rate information is unpredictable and can change unexpectedly.

At steps 512 and 514, the fair-value coefficient is calculated for the futures contract on index i. At step 512, the fitted coefficients \hat{α}ᵢ and \hat{β}ᵢ are provided in the following regression:

R_{i,t+1}=αᵢ+βᵢZₜ+εₜ. (1)

One of ordinary skill in the art would be able to perform this regression using a computer system, such as system 420, that has been programmed using well known mathematics techniques.

At step 514, the predicted fair-value adjusted price for the futures contract on index i is found using the index futures contract's settlement price, as reported by an exchange on a daily basis. Specifically, in one embodiment of the present invention, the predicted opening NAV of a futures contract on index i is computed as:

P*_{fi,t}=SETT_{fi,t}(1+\hat{α}+\hat{β}Zₜ). (2)

According to one embodiment of the current invention, the settlement price of the futures contract for index i is obtained from an exchange where it is assumed to be calculated as:

SETTₜ=\tilde{S}_{i,t}e^{(r-d)(T-t)}. (3)

This computation takes into account the cost of carry. Additionally, other variants of equation 3 might be used by exchanges in calculating the settlement price of the futures contract for index i. These other variant equations may take into account other considerations when calculating the settlement price.

Additionally, according to one embodiment of the present invention, a timestamp is associated with the contract's settlement price that is received from an exchange. The timestamp is used to show when the given price is valid. However, the timestamp is not determined by the time of the settlement price tick, which can and often does arrive later than the beginning of a potential stale period. Rather, the timestamp is determined using a series of rules that relate the timestamp to the time of the equity close or other user specified information. Additionally, users may manually set the timestamp. Once the timestamp has been determined, it is possible to then test the quality of the timestamp. This is done by examining the tick files to observe the prices of other ticks near the determined timestamp and making sure that the settlement price falls within the range of prices observed around the timestamp.

At step 516 the needed fair-value adjustments are outputted. In one embodiment the needed fair-value adjustment is outputted in the form of a fair-value adjustment coefficient, (1+\hat{α}+\hat{β}Zₜ), to be multiplied with the settlement price, SETT_{fi,t}, of the futures contract for index i. According to another embodiment, the fair-value adjusted price for the futures contract for index i, P*_{fi,t}, is outputted at step 516. Using these fair-value adjustments, mutual fund managers can properly value the index futures contracts that make up a portion of their portfolio.

The invention having been thus described, it will be apparent to those skilled in the art that the same may be varied in many ways without departing from the spirit of the invention. Any and all such modifications are intended to be encompassed within the scope of the herein recited claims. The following pages comprise appendixes 1-11.

### Appendices

### Appendix 1 FVM Coverage

| Country/ | Country/ | FVM Universe Size |
|---|---|---|
| Exchange | Exchange code | (as of Sep. 1, 2002) |
| Australia | AUS | 609 |
| Austria | AUT | 55 |
| Belgium | BEL | 91 |
| China | CHN | 1263 |
| Czech Republic | CZE | 7 |
| Denmark | DNK | 65 |
| Egypt | EGY | 52 |
| Germany | DEU | 320 |
| Finland | FIN | 91 |
| France | FRA | 672 |
| Greece | GRC | 338 |
| Hong Kong | HKG | 500 |
| Hungary | HUN | 23 |
| India | IND | 1178 |
| Indonesia | IDN | 97 |
| Ireland | IRL | 28 |
| Israel | ISR | 106 |
| Italy | ITA | 307 |
| Japan | JPN | 2494 |
| Jordan | JOR | 39 |
| Korea | KOR | 1611 |
| Malaysia | MYS | 556 |
| Netherlands | NLD | 140 |
| New Zealand | NZL | 69 |
| Norway | NOR | 82 |
| Philippines | PHL | 37 |
| Poland | POL | 133 |
| Portugal | PRT | 41 |
| Singapore | SGP | 254 |
| Spain | ESP | 117 |
| Sweden | SWE | 223 |
| Switzerland | CHE | 193 |
| Taiwan | TWN | 938 |
| Thailand | THA | 226 |
| Turkey | TUR | 288 |
| South Africa | ZAF | 179 |
| United Kingdom | GBR | 1092 |
| EuroNext (Ex.) | ENM | 245 |
| London Int. (Ex.) | LIN | 23 |
| Vertex (Ex.) | VXX | 28 |

### Appendix 2 Overnight Volatility for Consecutive and Non-Consecutive Trading Days

TABLE 2.1
Summary statistics of over-night returns for
consecutive and non-consecutive trading days

| | | | | Std. | Mini- | Maxi- |
|---|---|---|---|---|---|---|
| Country | Sub-sample | Samples | Mean | Dev. | mum | mum |
| AUS | Consecutive | 184 | 0.0072 | 0.0044 | 0.0037 | 0.0516 |
| | Non-conseq. | 54 | 0.0066 | 0.0030 | 0.0034 | 0.0244 |
| DEU | Consecutive | 189 | 0.0134 | 0.0040 | 0.0080 | 0.0360 |
| | Non-conseq. | 51 | 0.0132 | 0.0036 | 0.0082 | 0.0270 |
| FRA | Consecutive | 187 | 0.0110 | 0.0056 | 0.0056 | 0.0709 |
| | Non-conseq. | 52 | 0.0109 | 0.0040 | 0.0062 | 0.0272 |
| GBR | Consecutive | 187 | 0.0090 | 0.0028 | 0.0055 | 0.0309 |
| | Non-conseq. | 52 | 0.0086 | 0.0022 | 0.0058 | 0.0188 |
| HKG | Consecutive | 121 | 0.0090 | 0.0085 | 0.0012 | 0.0847 |
| | Non-conseq. | 38 | 0.0081 | 0.0041 | 0.0031 | 0.0198 |
| ITA | Consecutive | 186 | 0.0089 | 0.0050 | 0.0026 | 0.0448 |
| | Non-conseq. | 52 | 0.0094 | 0.0053 | 0.0045 | 0.0315 |
| JPN | Consecutive | 185 | 0.0130 | 0.0054 | 0.0077 | 0.0664 |
| | Non-conseq. | 51 | 0.0134 | 0.0040 | 0.0087 | 0.0270 |
| SGP | Consecutive | 129 | 0.0085 | 0.0061 | 0.0000 | 0.0521 |
| | Non-conseq. | 39 | 0.0071 | 0.0051 | 0.0021 | 0.0306 |

The average was taken across top 10% stocks by market cap.

TABLE 2.2
t-stats on the hypothesis that over-night volatilities for
consecutive and non-consecutive trading days are equal

| Country | AUS | DEU | FRA | GBR | HKG | ITA | JPN | SGP |
|---|---|---|---|---|---|---|---|---|
| t-statistic | −1.0840 | −0.1858 | −0.1025 | −1.5449 | −0.8913 | 0.5898 | 0.5093 | −1.4816 |

### Appendix 3 Model Selection: In-Sample Testing

TABLE 3.1
R² values of Model 1a

| Country | AUS | DEU | FRA | GBR | HKG | ITA | JPN | SGP |
|---|---|---|---|---|---|---|---|---|
| Top 5 | 0.182 | 0.234 | 0.270 | 0.227 | 0.265 | 0.236 | 0.208 | 0.218 |
| Top 5% | 0.157 | 0.206 | 0.208 | 0.157 | 0.230 | 0.230 | 0.176 | 0.190 |
| Top 10% | 0.150 | 0.202 | 0.195 | 0.147 | 0.227 | 0.218 | 0.169 | 0.194 |
| Top 25% | 0.148 | 0.170 | 0.188 | 0.135 | 0.219 | 0.207 | 0.160 | 0.196 |
| Top 50% | 0.141 | 0.187 | 0.187 | 0.131 | 0.216 | 0.202 | 0.157 | 0.181 |

TABLE 3.2
R² values of Model 1b

| Country | AUS | DEU | FRA | GBR | HKG | ITA | JPN | SGP |
|---|---|---|---|---|---|---|---|---|
| Top 5 | 0.212 | 0.248 | 0.291 | 0.254 | 0.368 | 0.269 | 0.264 | 0.244 |
| Top 5% | 0.190 | 0.235 | 0.240 | 0.186 | 0.326 | 0.261 | 0.213 | 0.225 |
| Top 10% | 0.183 | 0.232 | 0.227 | 0.176 | 0.318 | 0.254 | 0.205 | 0.230 |
| Top 25% | 0.182 | 0.201 | 0.221 | 0.164 | 0.308 | 0.244 | 0.196 | 0.231 |
| Top 50% | 0.176 | 0.217 | 0.219 | 0.161 | 0.303 | 0.239 | 0.193 | 0.219 |

TABLE 3.3
R² values of Model 1c

| Country | AUS | DEU | FRA | GBR | HKG | ITA | JPN | SGP |
|---|---|---|---|---|---|---|---|---|
| Top 5 | 0.201 | 0.242 | 0.287 | 0.234 | 0.362 | 0.257 | 0.258 | 0.237 |
| Top 5% | 0.180 | 0.225 | 0.232 | 0.173 | 0.317 | 0.249 | 0.204 | 0.214 |
| Top 10% | 0.174 | 0.221 | 0.219 | 0.163 | 0.310 | 0.241 | 0.196 | 0.218 |
| Top 25% | 0.172 | 0.190 | 0.212 | 0.152 | 0.298 | 0.229 | 0.187 | 0.219 |
| Top 50% | 0.169 | 0.207 | 0.210 | 0.149 | 0.293 | 0.225 | 0.183 | 0.207 |

### Appendix 4 Percentages of Significant Positive t-Statistics in Model 4

| Country | Top 5 | Top 5% | Top 10% | Top 25% | Top 50% |
|---|---|---|---|---|---|
| AUS | 4% | 7% | 7% | 9% | 9% |
| DEU | 3% | 4% | 4% | 3% | 3% |
| FRA | 3% | 6% | 7% | 6% | 6% |
| GBR | 2% | 5% | 5% | 5% | 5% |
| HKG | 1% | 16% | 11% | 12% | 11% |
| ITA | 8% | 4% | 4% | 6% | 6% |
| JPN | 8% | 5% | 6% | 7% | 8% |
| SGP | 4% | 5% | 5% | 5% | 5% |

### Appendix 5 Back-Testing Statistics for Sector Selection

| Country | Model | MAE | HIT | COR |
|---|---|---|---|---|
| AUS | 5a | 0.00811 | 0.58045 | 0.24491 |
| | 5b | 0.00980 | 0.56135 | 0.21495 |
| | 5c | 0.00933 | 0.56726 | 0.21523 |
| DEU | 5a | 0.00894 | 0.57505 | 0.35751 |
| | 5b | 0.00911 | 0.57318 | 0.34973 |
| | 5c | 0.00906 | 0.57318 | 0.35044 |
| FRA | 5a | 0.00863 | 0.61076 | 0.38524 |
| | 5b | 0.00879 | 0.60528 | 0.37601 |
| | 5c | 0.0087 | 0.60748 | 0.38054 |
| GBR | 5a | 0.00791 | 0.5706 | 0.3035 |
| | 5b | 0.0081 | 0.55771 | 0.27512 |
| | 5c | 0.00802 | 0.56333 | 0.28606 |
| HKG | 5a | 0.00821 | 0.53427 | 0.48282 |
| | 5b | 0.00842 | 0.50197 | 0.42804 |
| | 5c | 0.00834 | 0.50163 | 0.45438 |
| ITA | 5a | 0.00717 | 0.65735 | 0.43698 |
| | 5b | 0.00732 | 0.64411 | 0.3923 |
| | 5c | 0.00721 | 0.64942 | 0.41669 |
| JPN | 5a | 0.01283 | 0.56176 | 0.31748 |
| | 5b | 0.013 | 0.55242 | 0.31787 |
| | 5c | 0.0129 | 0.55837 | 0.32994 |
| SGP | 5a | 0.00842 | 0.5002 | 0.38348 |
| | 5b | 0.00858 | 0.47464 | 0.3363 |
| | 5c | 0.00853 | 0.47714 | 0.34281 |

### Appendix 6 Model Selection: Summary

TABLE 6.1
Back-testing Statistics for Model Selection

| Country | Model | MAE | HIT | COR |
|---|---|---|---|---|
| AUS | 1a | 0.00689 | 0.38419 | 0.23420 |
| | 2 | 0.00685 | 0.57900 | 0.25680 |
| | 3a | 0.00676 | 0.55182 | 0.29389 |
| DEU | 1a | 0.00924 | 0.21924 | 0.21648 |
| | 2 | 0.00856 | 0.58025 | 0.35898 |
| | 3a | 0.00866 | 0.51318 | 0.34475 |
| FRA | 1a | 0.00891 | 0.33451 | 0.27687 |
| | 2 | 0.00859 | 0.60057 | 0.38984 |
| | 3a | 0.00865 | 0.54468 | 0.36921 |
| GBR | 1a | 0.00801 | 0.31741 | 0.22521 |
| | 2 | 0.00787 | 0.56281 | 0.29165 |
| | 3a | 0.00778 | 0.51050 | 0.30350 |
| HKG | 1a | 0.00901 | 0.21209 | 0.21500 |
| | 2 | 0.00810 | 0.52780 | 0.48177 |
| | 3a | 0.00853 | 0.39942 | 0.33436 |
| ITA | 1a | 0.00740 | 0.45331 | 0.37068 |
| | 2 | 0.00695 | 0.66864 | 0.46543 |
| | 3a | 0.00710 | 0.60372 | 0.41537 |
| JPN | 1a | 0.01323 | 0.28534 | 0.20120 |
| | 2 | 0.01260 | 0.56862 | 0.34364 |
| | 3a | 0.01286 | 0.52440 | 0.30486 |
| SGP | 1a | 0.00861 | 0.22492 | 0.21045 |
| | 2 | 0.00845 | 0.49521 | 0.38399 |
| | 3a | 0.00845 | 0.46968 | 0.36077 |

TABLE 6.2
Arbitrage Profit Statistics of Model 2

| | No Model | | Model 2 | |
|---|---|---|---|---|
| Country | ARB | ARBBIG | ARB | ARBBIG |
| AUS | 0.00515 | 0.00880 | −0.00008 | 0.00112 |
| DEU | 0.00805 | 0.01332 | 0.00165 | 0.00247 |
| FRA | 0.00817 | 0.01413 | 0.00065 | 0.00186 |
| GBR | 0.00593 | 0.00937 | 0.00062 | 0.00082 |
| HKG | 0.00883 | 0.01728 | −0.00072 | 0.00274 |
| ITA | 0.00800 | 0.01320 | 0.00113 | 0.00219 |
| JPN | 0.01107 | 0.01812 | 0.00022 | 0.00244 |
| SGP | 0.00901 | 0.01459 | 0.00187 | 0.00400 |

### Appendix 7 Model Selection: Details by Country and Universe Segment

TABLE 7.1
AUS

| Model | Universe | ARB | ARBBIG | MAE | HIT | COR |
|---|---|---|---|---|---|---|
| No | Largest 10 | 0.00669 | 0.01149 | 0.00801 | 0 | 0 |
| Model | Top 5% | 0.00538 | 0.00919 | 0.00721 | 0 | 0 |
| | Top 10% | 0.00515 | 0.0088 | 0.00719 | 0 | 0 |
| | Top 25% | 0.00498 | 0.00855 | 0.00738 | 0 | 0 |
| | Top 50% | 0.0049 | 0.00843 | 0.00757 | 0 | 0 |
| 1a | Largest 10 | 0.00114 | 0.00339 | 0.00739 | 0.53612 | 0.34601 |
| | Top 5% | 0.00146 | 0.00346 | 0.00687 | 0.40611 | 0.24917 |
| | Top 10% | 0.00144 | 0.00337 | 0.00689 | 0.38419 | 0.2342 |
| | Top 25% | 0.00139 | 0.0033 | 0.00711 | 0.36607 | 0.22169 |
| | Top 50% | 0.00137 | 0.00328 | 0.00731 | 0.35978 | 0.21758 |
| 2 | Largest 10 | −0.0001 | 0.00151 | 0.00732 | 0.63953 | 0.32685 |
| | Top 5% | −0.00012 | 0.00111 | 0.00682 | 0.59624 | 0.27003 |
| | Top 10% | −0.00008 | 0.00112 | 0.00685 | 0.579 | 0.2568 |
| | Top 25% | −0.00013 | 0.00105 | 0.00708 | 0.56115 | 0.2449 |
| | Top 50% | −0.00014 | 0.00103 | 0.00729 | 0.55336 | 0.24053 |
| 3a | Largest 10 | 0.00077 | 0.00289 | 0.00712 | 0.66204 | 0.40646 |
| | Top 5% | 0.00082 | 0.00255 | 0.00671 | 0.57655 | 0.311 |
| | Top 10% | 0.0008 | 0.00247 | 0.00676 | 0.55182 | 0.29389 |
| | Top 25% | 0.00075 | 0.0024 | 0.00699 | 0.52932 | 0.27906 |
| | Top 50% | 0.00073 | 0.00236 | 0.0072 | 0.52096 | 0.27412 |

TABLE 7.2
DEU

| Model | Universe | ARB | ARBBIG | MAE | HIT | COR |
|---|---|---|---|---|---|---|
| No | Largest 10 | 0.00884 | 0.01431 | 0.00804 | 0 | 0 |
| Model | Top 5% | 0.00881 | 0.01455 | 0.00949 | 0 | 0 |
| | Top 10% | 0.00805 | 0.01332 | 0.00964 | 0 | 0 |
| | Top 25% | 0.00749 | 0.01246 | 0.00999 | 0 | 0 |
| | Top 50% | 0.00733 | 0.01211 | 0.01014 | 0 | 0 |
| 1a | Largest 10 | 0.00611 | 0.00986 | 0.00753 | 0.22468 | 0.28639 |
| | Top 5% | 0.00603 | 0.00997 | 0.00903 | 0.23224 | 0.23833 |
| | Top 10% | 0.00546 | 0.00905 | 0.00924 | 0.21924 | 0.21648 |
| | Top 25% | 0.00511 | 0.00852 | 0.00963 | 0.20612 | 0.19609 |
| | Top 50% | 0.00501 | 0.00828 | 0.0098 | 0.20068 | 0.19008 |
| 2 | Largest 10 | 0.00177 | 0.00237 | 0.00678 | 0.64455 | 0.45709 |
| | Top 5% | 0.00179 | 0.00264 | 0.00826 | 0.60729 | 0.39565 |
| | Top 10% | 0.00165 | 0.00247 | 0.00856 | 0.58025 | 0.35898 |
| | Top 25% | 0.00169 | 0.00262 | 0.00906 | 0.54877 | 0.32677 |
| | Top 50% | 0.00168 | 0.00253 | 0.00925 | 0.53764 | 0.31674 |
| 3a | Largest 10 | 0.00286 | 0.00419 | 0.0069 | 0.56199 | 0.44297 |
| | Top 5% | 0.00296 | 0.0046 | 0.00838 | 0.54314 | 0.37943 |
| | Top 10% | 0.00267 | 0.00416 | 0.00866 | 0.51318 | 0.34475 |
| | Top 25% | 0.00262 | 0.00418 | 0.00915 | 0.47773 | 0.31309 |
| | Top 50% | 0.00259 | 0.00406 | 0.00933 | 0.46559 | 0.30331 |

TABLE 7.3
FRA

| Model | Universe | ARB | ARBBIG | MAE | HIT | COR |
|---|---|---|---|---|---|---|
| No | Largest 10 | 0.00749 | 0.01355 | 0.0086 | 0 | 0 |
| Model | Top 5% | 0.00848 | 0.01478 | 0.0095 | 0 | 0 |
| | Top 10% | 0.00817 | 0.01413 | 0.00974 | 0 | 0 |
| | Top 25% | 0.00799 | 0.01375 | 0.00998 | 0 | 0 |
| | Top 50% | 0.00791 | 0.0136 | 0.01013 | 0 | 0 |
| 1a | Largest 10 | 0.00282 | 0.00568 | 0.00775 | 0.40181 | 0.34948 |
| | Top 5% | 0.00344 | 0.00648 | 0.00858 | 0.36276 | 0.30223 |
| | Top 10% | 0.00347 | 0.00641 | 0.00891 | 0.33451 | 0.27687 |
| | Top 25% | 0.0035 | 0.00636 | 0.00921 | 0.31943 | 0.26148 |
| | Top 50% | 0.00348 | 0.00632 | 0.00937 | 0.31441 | 0.25647 |
| 2 | Largest 10 | 0.00044 | 0.00207 | 0.00738 | 0.62345 | 0.43757 |
| | Top 5% | 0.00064 | 0.00199 | 0.00823 | 0.61696 | 0.41724 |
| | Top 10% | 0.00065 | 0.00186 | 0.00859 | 0.60057 | 0.38984 |
| | Top 25% | 0.00069 | 0.00184 | 0.00889 | 0.58716 | 0.37071 |
| | Top 50% | 0.00069 | 0.00182 | 0.00906 | 0.58155 | 0.36392 |
| 3a | Largest 10 | 0.00172 | 0.004 | 0.00743 | 0.63417 | 0.44633 |
| | Top 5% | 0.00217 | 0.00447 | 0.0083 | 0.5684 | 0.39612 |
| | Top 10% | 0.00211 | 0.00425 | 0.00865 | 0.54468 | 0.36921 |
| | Top 25% | 0.0021 | 0.00414 | 0.00895 | 0.52581 | 0.35209 |
| | Top 50% | 0.00208 | 0.00408 | 0.00912 | 0.51896 | 0.34583 |

TABLE 7.4
GBR

| Model | Universe | ARB | ARBBIG | MAE | HIT | COR |
|---|---|---|---|---|---|---|
| No | Largest 10 | 0.00691 | 0.01136 | 0.00716 | 0 | 0 |
| Model | Top 5% | 0.00631 | 0.00992 | 0.00818 | 0 | 0 |
| | Top 10% | 0.00593 | 0.00937 | 0.00831 | 0 | 0 |
| | Top 25% | 0.00566 | 0.00897 | 0.00833 | 0 | 0 |
| | Top 50% | 0.00555 | 0.00881 | 0.00838 | 0 | 0 |
| 1a | Largest 10 | 0.00234 | 0.00377 | 0.00656 | 0.45133 | 0.37389 |
| | Top 5% | 0.00264 | 0.00391 | 0.00785 | 0.33936 | 0.24468 |
| | Top 10% | 0.00255 | 0.00384 | 0.00801 | 0.31741 | 0.22521 |
| | Top 25% | 0.00248 | 0.00377 | 0.00807 | 0.30345 | 0.21218 |
| | Top 50% | 0.00245 | 0.00373 | 0.00813 | 0.29653 | 0.2067 |
| 2 | Largest 10 | 0.00045 | 0.00093 | 0.00637 | 0.62128 | 0.4187 |
| | Top 5% | 0.00067 | 0.00084 | 0.00769 | 0.57424 | 0.31393 |
| | Top 10% | 0.00062 | 0.00082 | 0.00787 | 0.56281 | 0.29165 |
| | Top 25% | 0.00059 | 0.00081 | 0.00793 | 0.55195 | 0.2765 |
| | Top 50% | 0.00058 | 0.00082 | 0.008 | 0.54409 | 0.26973 |
| 3a | Largest 10 | 0.00143 | 0.0023 | 0.00625 | 0.64191 | 0.45641 |
| | Top 5% | 0.00149 | 0.00206 | 0.0076 | 0.53333 | 0.32615 |
| | Top 10% | 0.00139 | 0.00198 | 0.00778 | 0.5105 | 0.3035 |
| | Top 25% | 0.00133 | 0.00192 | 0.00784 | 0.49243 | 0.28852 |
| | Top 50% | 0.00132 | 0.00192 | 0.00791 | 0.48295 | 0.28161 |

TABLE 7.5
HKG

| Model | Universe | ARB | ARBBIG | MAE | HIT | COR |
|---|---|---|---|---|---|---|
| No | Largest 10 | 0.01004 | 0.01881 | 0.00877 | 0 | 0 |
| Model | Top 5% | 0.00936 | 0.01748 | 0.00888 | 0 | 0 |
| | Top 10% | 0.00883 | 0.01728 | 0.00922 | 0 | 0 |
| | Top 25% | 0.00864 | 0.01691 | 0.0095 | 0 | 0 |
| | Top 50% | 0.00853 | 0.01671 | 0.00984 | 0 | 0 |
| 1a | Largest 10 | 0.00617 | 0.01302 | 0.00843 | 0.24006 | 0.27187 |
| | Top 5% | 0.00607 | 0.01251 | 0.00864 | 0.21252 | 0.21973 |
| | Top 10% | 0.00542 | 0.01211 | 0.00901 | 0.21209 | 0.215 |
| | Top 25% | 0.00531 | 0.01187 | 0.00931 | 0.20403 | 0.20461 |
| | Top 50% | 0.00524 | 0.01172 | 0.00967 | 0.1991 | 0.19836 |
| 2 | Largest 10 | −0.00068 | 0.00251 | 0.00723 | 0.58287 | 0.55452 |
| | Top 5% | −0.00036 | 0.0027 | 0.00766 | 0.53947 | 0.4973 |
| | Top 10% | −0.00072 | 0.00274 | 0.0081 | 0.5278 | 0.48177 |
| | Top 25% | −0.0007 | 0.00269 | 0.00847 | 0.51083 | 0.46141 |
| | Top 50% | −0.00068 | 0.00268 | 0.00885 | 0.49973 | 0.44866 |
| 3a | Largest 10 | 0.00343 | 0.00891 | 0.00772 | 0.4486 | 0.40204 |
| | Top 5% | 0.00358 | 0.00874 | 0.00811 | 0.40311 | 0.33979 |
| | Top 10% | 0.00309 | 0.00855 | 0.00853 | 0.39942 | 0.33436 |
| | Top 25% | 0.00302 | 0.00835 | 0.00886 | 0.38704 | 0.32143 |
| | Top 50% | 0.00297 | 0.00823 | 0.00924 | 0.37852 | 0.31254 |

TABLE 7.6
ITA

| Model | Universe | ARB | ARBBIG | MAE | HIT | COR |
|---|---|---|---|---|---|---|
| No | Largest 10 | 0.0077 | 0.01288 | 0.00742 | 0 | 0 |
| Model | Top 5% | 0.00785 | 0.01316 | 0.00781 | 0 | 0 |
| | Top 10% | 0.008 | 0.0132 | 0.00813 | 0 | 0 |
| | Top 25% | 0.00752 | 0.01243 | 0.00811 | 0 | 0 |
| | Top 50% | 0.00738 | 0.01218 | 0.00823 | 0 | 0 |
| 1a | Largest 10 | 0.00375 | 0.00671 | 0.0066 | 0.49902 | 0.42169 |
| | Top 5% | 0.00364 | 0.00661 | 0.00702 | 0.48206 | 0.40443 |
| | Top 10% | 0.00374 | 0.00661 | 0.0074 | 0.45331 | 0.37068 |
| | Top 25% | 0.00352 | 0.00625 | 0.00746 | 0.42347 | 0.33929 |
| | Top 50% | 0.00351 | 0.00619 | 0.00761 | 0.40986 | 0.32483 |
| 2 | Largest 10 | 0.00105 | 0.0022 | 0.00622 | 0.68189 | 0.49282 |
| | Top 5% | 0.00103 | 0.00222 | 0.0066 | 0.67604 | 0.4814 |
| | Top 10% | 0.00113 | 0.00219 | 0.00695 | 0.66864 | 0.46543 |
| | Top 25% | 0.00107 | 0.0021 | 0.00705 | 0.64978 | 0.42952 |
| | Top 50% | 0.00104 | 0.00203 | 0.00721 | 0.64241 | 0.41556 |
| 3a | Largest 10 | 0.00247 | 0.00451 | 0.00635 | 0.64194 | 0.44196 |
| | Top 5% | 0.00238 | 0.00441 | 0.00672 | 0.63101 | 0.43714 |
| | Top 10% | 0.00258 | 0.00456 | 0.0071 | 0.60372 | 0.41537 |
| | Top 25% | 0.00249 | 0.00442 | 0.0072 | 0.57543 | 0.38166 |
| | Top 50% | 0.00242 | 0.00429 | 0.00736 | 0.56619 | 0.3689 |

TABLE 7.7
JPN

| Model | Universe | ARB | ARBBIG | MAE | HIT | COR |
|---|---|---|---|---|---|---|
| No | Largest 10 | 0.01315 | 0.0219 | 0.01461 | 0 | 0 |
| Model | Top 5% | 0.01151 | 0.01884 | 0.0139 | 0 | 0 |
| | Top 10% | 0.01107 | 0.01812 | 0.01371 | 0 | 0 |
| | Top 25% | 0.01053 | 0.01728 | 0.0135 | 0 | 0 |
| | Top 50% | 0.01026 | 0.01687 | 0.01346 | 0 | 0 |
| 1a | Largest 10 | 0.00705 | 0.013 | 0.01412 | 0.32809 | 0.21275 |
| | Top 5% | 0.00556 | 0.01025 | 0.01336 | 0.2957 | 0.2097 |
| | Top 10% | 0.00537 | 0.0099 | 0.01323 | 0.28534 | 0.2012 |
| | Top 25% | 0.00511 | 0.00947 | 0.01309 | 0.27421 | 0.19042 |
| | Top 50% | 0.00501 | 0.00929 | 0.01307 | 0.26633 | 0.18405 |
| 2 | Largest 10 | 0.00069 | 0.00394 | 0.01302 | 0.5941 | 0.402 |
| | Top 5% | 0.0003 | 0.00263 | 0.01268 | 0.57613 | 0.3562 |
| | Top 10% | 0.00022 | 0.00244 | 0.0126 | 0.56862 | 0.34364 |
| | Top 25% | 0.00016 | 0.00229 | 0.01251 | 0.55762 | 0.3286 |
| | Top 50% | 0.00016 | 0.00226 | 0.01252 | 0.54821 | 0.31928 |
| 3a | Largest 10 | 0.00318 | 0.00735 | 0.01342 | 0.59127 | 0.37146 |
| | Top 5% | 0.00273 | 0.00606 | 0.01297 | 0.53681 | 0.31599 |
| | Top 10% | 0.00259 | 0.00578 | 0.01286 | 0.5244 | 0.30486 |
| | Top 25% | 0.00242 | 0.00548 | 0.01276 | 0.50813 | 0.29152 |
| | Top 50% | 0.00236 | 0.00538 | 0.01275 | 0.4964 | 0.283 |

TABLE 7.8
SGP

| Model | Universe | ARB | ARBBIG | MAE | HIT | COR |
|---|---|---|---|---|---|---|
| No | Largest 10 | 0.0097 | 0.01594 | 0.0088 | 0 | 0 |
| Model | Top 5% | 0.0095 | 0.01531 | 0.00901 | 0 | 0 |
| | Top 10% | 0.00901 | 0.01459 | 0.00905 | 0 | 0 |
| | Top 25% | 0.00874 | 0.01433 | 0.00949 | 0 | 0 |
| | Top 50% | 0.00872 | 0.0144 | 0.01003 | 0 | 0 |
| 1a | Largest 10 | 0.00625 | 0.01078 | 0.00829 | 0.23065 | 0.23009 |
| | Top 5% | 0.0057 | 0.0096 | 0.00849 | 0.23904 | 0.23037 |
| | Top 10% | 0.00543 | 0.0092 | 0.00861 | 0.22492 | 0.21045 |
| | Top 25% | 0.0053 | 0.00915 | 0.0091 | 0.21393 | 0.19466 |
| | Top 50% | 0.00531 | 0.00927 | 0.00966 | 0.20777 | 0.18836 |
| 2 | Largest 10 | 0.00227 | 0.00497 | 0.00813 | 0.52465 | 0.45103 |
| | Top 5% | 0.00198 | 0.00414 | 0.00835 | 0.51613 | 0.42137 |
| | Top 10% | 0.00187 | 0.004 | 0.00845 | 0.49521 | 0.38399 |
| | Top 25% | 0.00184 | 0.00408 | 0.00897 | 0.47021 | 0.34861 |
| | Top 50% | 0.00189 | 0.00424 | 0.00955 | 0.45434 | 0.33638 |
| 3a | Largest 10 | 0.00346 | 0.00656 | 0.00807 | 0.534 | 0.43719 |
| | Top 5% | 0.00338 | 0.00606 | 0.00832 | 0.4986 | 0.39822 |
| | Top 10% | 0.00324 | 0.00592 | 0.00845 | 0.46968 | 0.36077 |
| | Top 25% | 0.00318 | 0.00596 | 0.00899 | 0.43997 | 0.3284 |
| | Top 50% | 0.00323 | 0.00614 | 0.00957 | 0.42434 | 0.31679 |

### Appendix 8 Testing Naive Model

TABLE 8.1
AUS

| Model | Universe | ARB | ARBBIG | MAE | MAEBIG | HIT | COR |
|---|---|---|---|---|---|---|---|
| No | Largest 10 | 0.00342 | 0.00519 | 0.006 | 0.00668 | | |
| Model | Top 5% | 0.00248 | 0.00353 | 0.00511 | 0.00555 | | |
| | Top 10% | 0.00256 | 0.0034 | 0.00486 | 0.00524 | | |
| | Top 25% | 0.00231 | 0.00284 | 0.00501 | 0.0053 | | |
| 2 | Largest 10 | 0.00002 | 0.00061 | 0.00533 | 0.00552 | 0.69341 | 0.45846 |
| | Top 5% | 0.00017 | 0.00043 | 0.00488 | 0.00509 | 0.63251 | 0.33034 |
| | Top 10% | 0.00058 | 0.00073 | 0.00478 | 0.00504 | 0.61803 | 0.27761 |
| | Top 25% | 0.0009 | 0.00092 | 0.00508 | 0.00536 | 0.57594 | 0.16233 |
| 2′ | Largest 10 | −0.00423 | −0.00518 | 0.00766 | 0.00896 | 0.69376 | 0.4667 |
| | Top 5% | −0.00517 | −0.00683 | 0.00789 | 0.00951 | 0.63512 | 0.34349 |
| | Top 10% | −0.0051 | −0.00697 | 0.00798 | 0.00976 | 0.62051 | 0.29814 |
| | Top 25% | −0.00536 | −0.00758 | 0.0086 | 0.01054 | 0.5848 | 0.19984 |

TABLE 8.2
DEU

| Model | Universe | ARB | ARBBIG | MAE | MAEBIG | HIT | COR |
|---|---|---|---|---|---|---|---|
| No | Largest 10 | 0.00276 | 0.00482 | 0.00805 | 0.00922 | | |
| Model | Top 5% | 0.00303 | 0.0049 | 0.00744 | 0.00843 | | |
| | Top 10% | 0.00303 | 0.0045 | 0.00786 | 0.00862 | | |
| | Top 25% | 0.00068 | 0.00162 | 0.00802 | 0.00844 | | |
| 2 | Largest 10 | −0.00145 | −0.00139 | 0.00673 | 0.00706 | 0.67642 | 0.44973 |
| | Top 5% | −0.00145 | −0.00156 | 0.00685 | 0.00712 | 0.66986 | 0.43356 |
| | Top 10% | −0.0006 | −0.00085 | 0.00689 | 0.00709 | 0.63771 | 0.34808 |
| | Top 25% | −0.00133 | −0.00133 | 0.00767 | 0.00786 | 0.5876 | 0.2027 |
| 2′ | Largest 10 | −0.00302 | −0.00368 | 0.00722 | 0.00783 | 0.68187 | 0.49354 |
| | Top 5% | −0.00328 | −0.00424 | 0.00738 | 0.00797 | 0.67366 | 0.47319 |
| | Top 10% | −0.00288 | −0.00419 | 0.00767 | 0.00833 | 0.64677 | 0.39363 |
| | Top 25% | −0.00507 | −0.00684 | 0.00891 | 0.00987 | 0.59081 | 0.23571 |

TABLE 8.3
FRA

| Model | Universe | ARB | ARBBIG | MAE | MAEBIG | HIT | COR |
|---|---|---|---|---|---|---|---|
| No | Largest 10 | 0.00363 | 0.00478 | 0.00674 | 0.00726 | | |
| Model | Top 5% | 0.00358 | 0.00513 | 0.00754 | 0.00824 | | |
| | Top 10% | 0.00225 | 0.00353 | 0.0084 | 0.00895 | | |
| | Top 25% | 0.00169 | 0.00266 | 0.00865 | 0.00909 | | |
| 2 | Largest 10 | 0.00063 | 0.0006 | 0.006 | 0.00605 | 0.67137 | 0.43319 |
| | Top 5% | −0.00026 | −0.00018 | 0.0067 | 0.00683 | 0.65642 | 0.41516 |
| | Top 10% | −0.00110 | −0.00111 | 0.00792 | 0.00812 | 0.61452 | 0.29315 |
| | Top 25% | −0.00082 | −0.00082 | 0.00848 | 0.00875 | 0.56744 | 0.1588 |
| 2′ | Largest 10 | −0.00202 | −0.00311 | 0.00665 | 0.00706 | 0.67111 | 0.44876 |
| | Top 5% | −0.00214 | −0.0028 | 0.00737 | 0.00788 | 0.65817 | 0.43423 |
| | Top 10% | −0.00352 | −0.00449 | 0.0088 | 0.00947 | 0.615 | 0.31833 |
| | Top 25% | −0.00400 | −0.00527 | 0.00983 | 0.01082 | 0.57752 | 0.19815 |

### Appendix 9 Testing ETFs

TABLE 9.1
AUS

| Model | Universe | ARB | ARBBIG | MAE | MAEBIG | HIT | COR |
|---|---|---|---|---|---|---|---|
| No | Largest 10 | 0.00342 | 0.00521 | 0.00602 | 0.00671 | | |
| Model | Top 5% | 0.00259 | 0.00367 | 0.00514 | 0.00558 | | |
| | Top 10% | 0.00256 | 0.00342 | 0.00488 | 0.00526 | | |
| | Top 25% | 0.00236 | 0.00284 | 0.00506 | 0.00533 | | |
| 2 | Largest 10 | 0.00002 | 0.00063 | 0.00534 | 0.00553 | 0.69472 | 0.46086 |
| | Top 5% | 0.00016 | 0.00043 | 0.00489 | 0.0051 | 0.63354 | 0.3325 |
| | Top 10% | 0.00058 | 0.00074 | 0.00479 | 0.00505 | 0.61894 | 0.27897 |
| | Top 25% | 0.00092 | 0.0009 | 0.00513 | 0.00539 | 0.57762 | 0.16286 |
| 2″ | Largest 10 | 0.00326 | 0.00539 | 0.00628 | 0.00685 | 0.53509 | 0.09757 |
| | Top 5% | 0.00259 | 0.004 | 0.0056 | 0.00597 | 0.52686 | 0.0832 |
| | Top 10% | 0.00266 | 0.00376 | 0.00514 | 0.00547 | 0.52276 | 0.0515 |
| | Top 25% | 0.0025 | 0.00315 | 0.00518 | 0.0054 | 0.51313 | 0.01582 |
| 2′″ | Largest 10 | −0.00011 | 0.00085 | 0.00555 | 0.00567 | 0.67927 | 0.43497 |
| | Top 5% | 0.00011 | 0.00063 | 0.0051 | 0.00525 | 0.63612 | 0.32335 |
| | Top 10% | 0.00055 | 0.00096 | 0.00489 | 0.00512 | 0.62179 | 0.27292 |
| | Top 25% | 0.00095 | 0.00112 | 0.00509 | 0.00531 | 0.58096 | 0.16344 |

TABLE 9.2
DEU

| Model | Universe | ARB | ARBBIG | MAE | MAEBIG | HIT | COR |
|---|---|---|---|---|---|---|---|
| No | Largest 10 | 0.00275 | 0.00482 | 0.0081 | | | |
| Model | Top 5% | 0.00289 | 0.00486 | 0.00778 | | | |
| | Top 10% | 0.00317 | 0.00486 | 0.00813 | | | |
| | Top 25% | 0.00101 | 0.00205 | 0.00811 | | | |
| 2 | Largest 10 | −0.0015 | −0.0015 | 0.00677 | 0.00712 | 0.67709 | 0.45018 |
| | Top 5% | −0.0014 | −0.0014 | 0.00652 | 0.00686 | 0.67915 | 0.46444 |
| | Top 10% | −0.0007 | −0.001 | 0.00713 | 0.00738 | 0.66037 | 0.39675 |
| | Top 25% | −0.0012 | −0.0012 | 0.00767 | 0.00791 | 0.59603 | 0.22961 |
| 2″ | Largest 10 | 0.00126 | 0.00235 | 0.0082 | 0.0094 | 0.5854 | 0.1769 |
| | Top 5% | 0.00144 | 0.00241 | 0.00789 | 0.00902 | 0.59559 | 0.17533 |
| | Top 10% | 0.00185 | 0.00263 | 0.00834 | 0.00919 | 0.57656 | 0.15029 |
| | Top 25% | 0.00062 | 0.00111 | 0.00833 | 0.00883 | 0.53509 | 0.08099 |
| 2′″ | Largest 10 | −0.0017 | −0.0018 | 0.00697 | 0.00744 | 0.67744 | 0.41033 |
| | Top 5% | −0.0013 | −0.0016 | 0.0066 | 0.00702 | 0.68793 | 0.43348 |
| | Top 10% | −0.0007 | −0.0012 | 0.00739 | 0.00774 | 0.65308 | 0.35298 |
| | Top 25% | −0.0013 | −0.0015 | 0.00782 | 0.00808 | 0.58303 | 0.19593 |

TABLE 9.3
FRA

| Model | Universe | ARB | ARBBIG | MAE | MAEBIG | HIT | COR |
|---|---|---|---|---|---|---|---|
| No | Largest 10 | 0.00362 | 0.00478 | 0.00678 | 0.0073 | | |
| Model | Top 5% | 0.00361 | 0.00521 | 0.00779 | 0.00861 | | |
| | Top 10% | 0.00225 | 0.00355 | 0.00844 | 0.00901 | | |
| | Top 25% | 0.00181 | 0.00279 | 0.00861 | 0.00906 | | |
| 2 | Largest 10 | 0.00059 | 0.00056 | 0.00603 | 0.00608 | 0.67073 | 0.43278 |
| | Top 5% | −0.00046 | −0.00043 | 0.0069 | 0.0071 | 0.65818 | 0.42001 |
| | Top 10% | −0.00113 | −0.00116 | 0.00797 | 0.00817 | 0.61424 | 0.29396 |
| | Top 25% | −0.00073 | −0.00076 | 0.0084 | 0.00869 | 0.57018 | 0.16766 |
| 2″ | Largest 10 | 0.00289 | 0.00396 | 0.00699 | 0.00752 | 0.57545 | 0.09361 |
| | Top 5% | 0.00259 | 0.00399 | 0.00803 | 0.00876 | 0.56614 | 0.09608 |
| | Top 10% | 0.00143 | 0.00247 | 0.00891 | 0.00947 | 0.54977 | 0.06079 |
| | Top 25% | 0.00121 | 0.00201 | 0.00921 | 0.00967 | 0.538 | 0.03295 |
| 2′″ | Largest 10 | 0.0005 | 0.00043 | 0.00603 | 0.00611 | 0.67773 | 0.43952 |
| | Top 5% | −0.00035 | −0.00034 | 0.00686 | 0.00706 | 0.65839 | 0.42125 |
| | Top 10% | −0.00115 | −0.00127 | 0.00804 | 0.00826 | 0.61884 | 0.3066 |
| | Top 25% | −0.00084 | −0.00095 | 0.00868 | 0.00895 | 0.57626 | 0.18432 |

### Appendix 10 Testing ADRs

| Ticker | Company | Model | ARB | MAE | COR | HIT |
|---|---|---|---|---|---|---|
| BP | BP PLC | No model | 0.0087 | 0.0104 | | |
| | | 2 | −0.0007 | 0.0058 | 0.86792 | 0.8296 |
| | | ADR | −0.0009 | 0.0062 | 0.8679 | 0.8666 |
| VOD | VODAFONE GROUP PLC | No model | 0.0139 | 0.017 | | |
| | | 2 | −0.0018 | 0.0106 | 0.86538 | 0.7809 |
| | | ADR | −0.0004 | 0.0093 | 0.8301 | 0.8654 |
| GSK | GLAXOSMITHKLINE PLC | No model | 0.0084 | 0.0107 | | |
| | | 2 | 0.0015 | 0.0069 | 0.8 | 0.7582 |
| | | ADR | −0.0009 | 0.0062 | 0.8909 | 0.8448 |
| AZN | ASTRAZENECA PLC | No model | 0.0088 | 0.0125 | | |
| | | 2 | −0.0003 | 0.009 | 0.81034 | 0.6846 |
| | | ADR | 0 | 0.0093 | 0.8275 | 0.7589 |
| SHEL | SHELL TRANSPRT&TRADNG CO | No model | 0.01 | 0.0115 | | |
| | PLC | 2 | 0.0001 | 0.0063 | 0.85185 | 0.8223 |
| | | ADR | 0.0002 | 0.0072 | 0.8518 | 0.7821 |
| ULVR | UNILEVER PLC | No model | 0.0073 | 0.0087 | | |
| | | 2 | 0.0023 | 0.007 | 0.81132 | 0.5979 |
| | | ADR | −0.0002 | 0.0075 | 0.7777 | 0.5949 |

### Appendix 11 When FVM Adjustment Factors Should be Applied?

TABLE 11.1
FTSE 100 (model 2), threshold on adjustment factors.

| | | | | |
|---|---|---|---|---|
| Threshold | ARB | MAE | HIT | COR |

Equally weighted

| | | | | |
|---|---|---|---|---|
| 0.000: | 0.00023 | 0.01008 | 0.55337 | 0.43362 |
| 0.005: | 0.00125 | 0.01006 | 0.69370 | 0.42218 |
| 0.010: | 0.00242 | 0.01030 | 0.79698 | 0.36476 |
| 0.015: | 0.00321 | 0.01054 | 0.88848 | 0.30374 |
| 0.020: | 0.00367 | 0.01073 | 0.89762 | 0.24505 |
| 0.025: | 0.00391 | 0.01080 | 0.89065 | 0.20415 |
| 0.030: | 0.00410 | 0.01091 | 0.83730 | 0.14949 |

Market Cap weighted

| | | | | |
|---|---|---|---|---|
| 0.000: | 0.00005 | 0.00805 | 0.55337 | 0.43362 |
| 0.005: | 0.00111 | 0.00813 | 0.69370 | 0.42218 |
| 0.010: | 0.00250 | 0.00862 | 0.79698 | 0.36476 |
| 0.015: | 0.00354 | 0.00901 | 0.88848 | 0.30374 |
| 0.020: | 0.00425 | 0.00948 | 0.89762 | 0.24505 |
| 0.025: | 0.00457 | 0.00960 | 0.89065 | 0.20415 |
| 0.030: | 0.00497 | 0.00988 | 0.83730 | 0.14949 |

TABLE 11.2
FTSE 100 (model 2), threshold on US intraday market returns.

| | | | | |
|---|---|---|---|---|
| Threshold | ARB | MAE | HIT | COR |

Equally weighted

| | | | | |
|---|---|---|---|---|
| 0.000: | 0.00023 | 0.01008 | 0.61079 | 0.43363 |
| 0.005: | 0.00043 | 0.01003 | 0.67367 | 0.43691 |
| 0.010: | 0.00129 | 0.01001 | 0.76792 | 0.42961 |
| 0.015: | 0.00167 | 0.01014 | 0.78081 | 0.40947 |
| 0.020: | 0.00245 | 0.01022 | 0.82057 | 0.39039 |
| 0.025: | 0.00358 | 0.01067 | 0.85583 | 0.25457 |
| 0.030: | 0.00376 | 0.01074 | 0.83667 | 0.22756 |

Market Cap weighted

| | | | | |
|---|---|---|---|---|
| 0.000: | 0.00002 | 0.00805 | 0.68386 | 0.43363 |
| 0.005: | 0.00029 | 0.00800 | 0.76936 | 0.43691 |
| 0.010: | 0.00146 | 0.00814 | 0.85744 | 0.42961 |
| 0.015: | 0.00197 | 0.00842 | 0.86856 | 0.40947 |
| 0.020: | 0.00296 | 0.00868 | 0.90969 | 0.39039 |
| 0.025: | 0.00444 | 0.00956 | 0.92642 | 0.25457 |
| 0.030: | 0.00466 | 0.00966 | 0.91461 | 0.22756 |

TABLE 11.3
FTSE 100 (no model).

| | |
|---|---|
| ARB | MAE |

Equally weighted

| | |
|---|---|
| 0.00435 | 0.01098 |

Mcap weighted

| | |
|---|---|
| 0.00542 | 0.0101 |

We claim:

1. A computer implemented method for determining fair-value prices of a futures contract of index i having foreign constituent securities, comprising the steps of:
at a computer, receiving electronic data for the index i;
at a computer, calculating alpha (α) and beta (β) coefficients using a regression analysis, wherein the alpha (α) coefficient represents a risk-adjusted measure of return on the index i, and the beta (β) coefficient represents a metric that is related to a correlation between an overnight return of the index i and a proxy market;
at a computer, receiving a settlement price (SETTᵢ) of the futures contract for index i; and
at a computer, calculating a fair-value adjusted price for the futures contract of index i based at least in part on the alpha (α) and beta (β) coefficients, the settlement price (SETTᵢ) of the futures contract for index i, and at least one return of a predetermined factor (Zᵢ) during a stale period.

2. The computer implemented method of claim 1, wherein calculating alpha and beta coefficients using a regression analysis comprises solving the equation:
R_{i,t+1}=αᵢ+βᵢZₜ+εₜ.

3. The computer implemented method of claim 1, wherein the settlement price of the futures contract for index i is received from an exchange.

4. The computer implemented method of claim 1, wherein the settlement price of the futures contract for index i is determined by solving the equation or a variant of the equation:
SETTᵢ=\tilde{S}_{i,t}e^{(r-d)(T-t)}.

5. The computer implemented method of claim 1, wherein calculating the fair-value adjusted price for the futures contract of index i comprises solving the equation:
P*_{fi,t}=SETT_{fi,t}(1+\hat{α}+\hat{β}Zₜ).

6. The computer implemented method of claim 1, wherein the predetermined factor is one of: an index futures contract that is traded 24 hours/day or a country-level exchange-traded fund.

7. The computer implemented method of claim 1, further comprising the step of:
at a computer, outputting a fair-value adjustment coefficient (1+\hat{α}+\hat{β}ₜ).

8. The computer implemented method of claim 1, further comprising the step of:
at a computer, outputting the fair-value adjusted price for the futures contract for index i (P*_{fi,t}).

9. A system for determining fair-value prices of a futures contract of index i having foreign constituent securities, the system comprising:
a fair-value computation server connected to an electronic data network and configured to receive electronic data for the index i from data sources via the electronic data network, to calculate alpha (α) and beta (β) coefficients using a regression analysis, receive a futures contract settlement price (SETTᵢ) for index i, and calculate a fair-value adjusted price for the futures contract of index i based at least in part on the alpha (α) and beta (β) coefficients, the settlement price (SETTᵢ) of the futures contract for index i, and at least one return of a predetermined factor (Zₜ) during a stale period, wherein the alpha (α) coefficient represents a risk-adjusted measure of return on the index i, and the beta (β) coefficient represents a metric that is related to a correlation between an overnight return of the index i and a proxy market.

10. The system of claim 9, wherein the fair-value computation server is further configured to calculate the alpha and beta coefficients using a regression analysis comprising solving the equation:
R_{i,t+1}=αᵢ+βᵢZₜ+εₜ.

11. The system of claim 9, wherein the fair-value computation server is further configured to receive the settlement price of the futures contract for index i from an exchange.

12. The system of claim 9, wherein the fair-value computation server is further configured to determine the settlement price of the futures contract for index i by solving the equation or a variant of the equation:
SETTᵢ=\tilde{S}_{i,t}e^{(r-d)(T-t)}.

13. The system of claim 9, wherein the fair-value computation server is further configured to calculate the fair-value adjusted price for the futures contract of index i by solving the equation:
P*_{fi,t}=SETT_{fi,t}(1+\hat{α}+\hat{β}Zₜ).

14. The system of claim 9, wherein the predetermined factor is one of: an index futures contract that is traded 24 hours/day or a country-level exchange-traded fund.

15. The system of claim 9, wherein the fair-value computation server is further configured to output a fair-value adjustment coefficient (1+\hat{α}+\hat{β}Zₜ).

16. The system of claim 9, wherein the fair-value computation server is further configured to output the fair-value adjusted price for the futures contract for index i (P*_{fi,t}).

17. A system for determining fair-value prices of a futures contract of index i having foreign constituent securities, comprising:
means for receiving electronic data for the index i;
means for calculating alpha (α) and beta (β) coefficients using a regression analysis, wherein the alpha (α) coefficient represents a risk-adjusted measure of return on the index i, and the beta (β) coefficient represents a metric that is related to a correlation between an overnight return of the index i and a proxy market;
means for receiving a settlement price (SETTᵢ) of the futures contract for index i; and
means for calculating a fair-value adjusted price for the futures contract of index i based at least in part on the alpha (α) and beta (β) coefficients, the settlement price of the futures contract (SETTᵢ) for index i, and at least one return of a predetermined factor (Zₜ) during a stale period.

18. The system of claim 17, wherein said means for calculating alpha and beta coefficients uses a regression analysis comprises solving the equation:
R_{i,t+1}=αᵢ+βᵢZₜ+εₜ.

19. The system method of claim 17, wherein the settlement price of the futures contract for index i is received from an exchange.

20. The system of claim 17, wherein the settlement price of the futures contract for index i is determined by solving the equation or a variant of the equation:
SETTᵢ=\tilde{S}_{i,t}e^{(r-d)(T-t)}.

21. The system of claim 17, wherein said means for calculating the fair-value adjusted price for the futures contract of index i solves the equation:
P*_{fi,t}=SETT_{fi,t}(1+\hat{α}+\hat{β}Zₜ).

22. The system of claim 17, wherein the predetermined factor is one of: an index futures contract that is traded 24 hours/day or country-level exchange-traded fund.

23. The system of claim 17, further comprising:
means for outputting a fair-value adjustment coefficient (1+\hat{α}+\hat{β}Zₜ).

24. The system of claim 17, further comprising:
means for outputting the fair-value adjusted price for the futures contract for index i (P*_{fi,t}).
